(19) United States
(12) Patent Application Publication
(10) Pub. No.: US 2002/0103811 A1
(43) Pub. Date: Aug. 1, 2002

(54) Method and apparatus for locating and exchanging clinical information

(76) Inventors: Karl Erich Fankhauser, Martinez, CA (US); Brian Daniel Terbush, San Francisco, CA (US)

Correspondence Address: MOORE & VAN ALLEN, PLLC, 2200 W MAIN STREET, SUITE 800, DURHAM, NC, 27705, US

(21) Appl. No.: 09/770,166

(22) Filed: Jan. 26, 2001

(51) Int. Cl. G06F 7/00; G06F 17/30

(52) U.S. Cl. 707/104.1; 707/4

(57) ABSTRACT

Method and apparatus for locating and exchanging clinical information. A method and system are provided for locating and accessing information across a network such as the Internet in a secure manner. With distributed health care records, the system makes it possible to access all parts of a patient's clinical health record even though individual records are dispersed across diverse organizations and providers. One or more servers contain a correlation system that accesses databases of universal person objects, and information on what records are available and where they are located. The universal person objects and location information is added to as the server receives metadata from providers. Providers who need to find a clinical record can access the server over the network. Once a record has been located, a provider can access a record in a standard format, and in a secure manner.

### BACKGROUND

1. Field of the Invention

This invention relates to software and systems for locating information records in a network containing widely distributed information. The invention is particularly useful to aid in the location and retrieval of clinical records so that a caregiver can gather information on a patient's medical history.

2. Description of the Problem

Systems for capturing clinical and administrative information about patients have been developed and implemented throughout the health care industry. In general, these systems have evolved through a best-of-breed approach where systems from different vendors and operating on different platforms have been implemented within one organization, and it is sometimes difficult to access information in one system from another system. An even more difficult problem arises because health care consumers typically frequent multiple providers, leading to an even greater distribution of the clinical information that could aid in providing better and more efficient care. Health care providers have a desire to access all of the information about a patient available to them at the time of care; without concern for where the information is actually stored and who is the actual custodian of the patient information.

A current problem with such sharing of clinical information is the lack of a universal patient identifier (ID). Patients are currently known by identifiers within a specific system by a local ID. It is not uncommon for a patient with records distributed throughout even a single organization to have several local ID's and no common ID within that organization. It is also difficult to know where a patient has been treated, and how their records are accessed. The idea of sending clinical information to a central repository is poorly received by the health care industry. This solution implies a loss of control over the gathered clinical information, possibly leading to a loss of competitive advantage, as well as the potential for a loss of privacy in health care records.

As a result of the above problems, there is currently no way for health care providers to find, access, and view the clinical information that has been collected by another provider without a prearranged interchange, either electronic or paper. This limits or precludes the availability of clinical information at the time that it is needed. However, the Internet, a vast network of computers and networks connected together, is conducive to exchanging information, and access to the Internet is relatively easy and inexpensive. There is a need for a system and method that would allow access of records, such as clinical records, between organizations over the Internet. Such a system should provide for such access to be secure, and should provide a way to index such records so that they can be located and accessed wherever they are, without having to be initially transmitted to a central repository.

### SUMMARY

The present invention solves the above-described problem by providing a method and system for locating and accessing information across the Internet in a secure manner. As used with distributed health care records or patient clinical records, the system for locating and accessing information described in the current invention makes it possible to access all parts of a patient's clinical health record even though individual records are dispersed across diverse organizations and providers. Additionally, the system provides a mechanism to allow only the records that are permissible for a health care provider to view to actually be viewed, thus guaranteeing a patient's right to privacy and limiting the amount of sensitive information sent across the network. In one embodiment, the invention is enabled by a server containing a correlation system and a database of universal person objects, as well as information on what records are available and where they are located. Each universal person object serves as an identifier for a particular patient. Once a record for a patient is located and determined to be available for viewing, it can be retrieved and viewed in a standardized format.

In one embodiment of the invention, the server software includes interface layers, a communications infrastructure, and a security layer. Various services interact with these layers including a person identification service which provides interfaces to look up correlated persons and to add new persons to the system, and a clinical information locator service that locates the clinical records associated with a universal person object. A correlation system can search the database of universal person objects to identify all entries related to a patient, patient identifiers that are specific to an organization where the patient has been treated, and organization identifiers that are specific to the origination where the patient has been treated.

The universal person object is built and added to in one embodiment as the server receives metadata from providers. The metadata includes at least a patient demographic information and clinical information locator data. The metadata can be received in batch transactions, through a push agent, or through a pull agent or transactionally. The metadata is sent to a metadata store, and a search is conducted to find any existing demographic data corresponding to the patient identifier. If a match is found the universal person object is updated with any new information. If no match exists for the patient, a new universal person object is created. All the appropriate information is stored in the database so that the information is associated in the hierarchy we call a universal person object. The universal person object includes, in one embodiment, a person class containing references to person specific data. This person class can also track historical instances of the data. The universal person object also includes a person identifier class with references to one or more person identifiers that may be used locally, and a domain identifier class associated with the person class, which identifies the local systems that supplied the person identifiers. If a server is one of multiple servers maintaining databases of universal person objects according to the invention for multiple domains, the universal person object may be forwarded to a parent server so that records can be “federated” across the multiple domains.

Providers who need to find a clinical record can access the server over a network such as the Internet. In one embodiment, a provider uses the system by first sending a query from a certified application to a primary domain server. The query is “correlated” at the server by accessing at least the database for that server. If possible, locator data is retrieved, and is filtered according to one or more policies. The locator data is provided to the provider application. A step can be added wherein the provider narrows down the possible record selections by entering parameters which are applied to the list of records presented. In any case, the provider can access records in an automated fashion directly from a remote system. In one embodiment, multiple servers in multiple domains can work together. The database initially accessed in a query may contain a pointer to a remote domain containing a remote server with a remote correlation system and a remote database of universal person objects.

The policies which are used to filter the information supplied to a provider include security policies which can be edited with a security policy editor. These security policies are determined by the provider of the metadata server services. The policies also include consent policies, which can be edited with a consent policy editor. Consent policies are set by the patient to whom the records apply. The security policies and consent policies ensure that privacy is protected for clinical records that are located and accessed using the invention.

In one embodiment, computer software is used to implement many aspects of the present invention. The software can be stored on a media. The media can be magnetic such as diskette, tape, or fixed disc, or optical, such as a CD-ROM. The software can also be stored in a semiconductor device. Additionally, the software can be supplied via the Internet or some other type of network. Workstations or computer systems that typically run the software include a plurality of input/output devices and a processor system. The software in combination with the computer systems, peripheral hardware, and the network provides the means to execute the methods and maintain the indexes that carry out the invention.

### BRIEF DESCRIPTION OF THE DRAWINGS

FIG. 1 illustrates the network architecture according to one embodiment of the present invention.

FIG. 2 is a block diagram illustrating an embodiment of the architecture of a server that implements many aspects of the invention.

FIG. 3 is a block diagram illustrating how the layers of the server architecture interact according to one embodiment of the invention.

FIG. 4 illustrates the hierarchical organization of a domain of servers according to one embodiment of the invention.

FIG. 5 illustrates a method for populating the server with metadata and building a database of universal person objects system from data according to one embodiment of the invention.

FIG. 6 illustrates a method of distributing and federating metadata across a distributed network according to an embodiment of the invention.

FIG. 7 illustrates the components of a mapper utility, which enables some embodiments of the invention.

FIG. 8 shows a block diagram of the run time components of the architecture of the invention according to one embodiment, including how the queries for service are activated and the results are returned.

FIG. 9 illustrates a method of handling the XML request to access the database according to an embodiment of the invention.

FIG. 10 illustrates how two providers interact with each other after receiving clinical information locator data from a server according to one embodiment of the invention.

FIG. 11 illustrates how complex object based services are accessed using a protocol based on HTTP and XML according to one embodiment of the invention.

FIG. 12 illustrates one deployment of components of the invention in an application server environment.

FIG. 13 depicts the function of an application server in providing high availability to the server according to one embodiment of the invention.

FIG. 14 illustrates the use of a certificate authority in providing authentication and public key infrastructure (PKI) services in conjunction with an embodiment of the invention.

FIG. 15 illustrates the sequence of events that take place to validate a user against an LDAP server in one embodiment of the invention.

FIG. 16 illustrates the runtime sequence of operations of an object generated by the mapper utility.

FIG. 17 is a flowchart depicting the method executed when the server is queried for patient information in one embodiment of the invention.

FIG. 18 is an activity diagram depicting the flow of events involved in utilizing a push agent to send data to the server in one embodiment of the invention. FIG. 18 is divided into FIGS. 18-A and 18-B for convenience.

FIG. 19 is a block diagram showing the method of a policy management subsystem which can be used with one embodiment of the invention.

FIG. 20 is a block diagram showing the components of the policy management subsystem.

FIG. 21 further illustrates the components of the policy management subsystem and how they capture policy data on clinical information

FIG. 22 is a block diagram, which illustrates the structure used and method for analyzing patient demographic data and correlating it against existing information to create or update a universal person Oobject according to one embodiment of the invention.

FIG. 23 is a block diagram illustrating how data is transmitted in a write metadata transaction according to an embodiment of the invention.

FIG. 24 provides an XML document type definition (DTD) used to describe the message envelope and the payload containers transmitted to the system in the write metadata transaction.

FIG. 25 provides the XML DTD used to describe the data transmitted in the write metadata transaction. FIG. 25 is divided into FIGS. 25-A through 25-G for convenience.

FIG. 26 provides the XML DTD used to describe the data transmitted in delete metadata transaction according to one embodiment of the invention. FIG. 26 is divided into FIGS. 26-A through 26-D for convenience.

FIG. 27 provides the XML DTD used to describe the data transmitted in merge metadata transaction according to one embodiment of the invention. FIG. 27 is divided into FIGS. 27-A through 27-G for convenience.

FIG. 28 illustrates the class hierarchy for a universal person object for identifying and finding patients, their providers and the organizations that have provided treatment according to one embodiment of the invention.

FIG. 29 is a detailed sequence diagram showing how queries are processed according to one embodiment of the invention.

FIG. 30 is a block diagram of an example general purpose computing platform that can be used to implement some aspects of the invention.

### DETAILED DESCRIPTION OF ONE OR MORE EMBODIMENTS

The present invention provides a method and system for locating and accessing clinical information across the Internet in a secure manner. The system for locating and accessing clinical information described herein makes it possible to access all parts of a patient's clinical health record even though the records are dispersed across diverse locations. Additionally, the system provides a mechanism to allow only the records that are permissible for a health care provider to view to actually be viewed, thus guaranteeing a patient's right to privacy and limiting the amount of sensitive information sent across a network.

In one embodiment, various clinical systems send metadata to a server that is a domain server for a collection of systems. We call this server a “metadata server” or an “exchange server.” We call a system of one or more servers and software that implements the invention an “exchange system” or “the exchange.” This domain can encompass an organization, an organizational network, or a community, whether it is a county, a state, region, or country. In one embodiment, each lower level domain forwards a part of its information to the parent level, thus guaranteeing that a search across domains will find all of the patient metadata that has been gathered.

The captured metadata includes organizational demographic information, patient demographic data, and clinical record locator data. The organizational data is used to provide easy access to an organization should it be necessary to call or fax information to or from that organization. The patient demographic data is used as a means of finding patient matches across domains. Without a universal patient identifier, patient records must be found by matching a number of traits or attributes that can be gathered from the majority of clinical systems.

The various processes that implement the invention are initiated when clinical systems send the patient metadata to the exchange server. This information is used to correlate the patient data that describes where the patient has been seen and where patient records may exist. This information can be sent to the server in a number of different ways. The information can be sent in batch transactions (convenient for most health care systems). Information can also be transmitted by using agents. These agents may either push or pull the information from the clinical system that is the source of the information. A “pull” agent is an agent that iteratively searches through the clinical system for new records that it needs and forwards these records to the exchange server. In the “push” model, the exchange server is registered as a party interested in the information generated by the agent. When new data is received, it is published to the exchange server, which then writes the data to its own databases of universal person objects and clinical information locator data. Any other type of event may be used to trigger sending the metadata to the exchange server. In one embodiment, an authentication server constantly verifies the clinical system and its agents to validate that the data is from a trusted source.

In order for a health care provider to access distributed clinical information, the provider first queries the metadata server. The server searches the database of universal person objects using a correlation system that correlates the patients across all of the health care facilities where they have been registered. The server provides matches to the patient based on the submitted demographic data. The matches indicate where a patient has been seen and how they are identified in that organization. In one embodiment, when a user clicks on an organization name, the server can also provide information on how to contact that organization. This information alone is valuable to the health care provider, who now has knowledge of where a patient has been treated and how to contact the organization to request information about the patient.

Subsequently, the health care provider can narrow a search for records to one organization, or to a type of clinical record in which they are interested. Other filters and constraints (such as a date range) can also be applied. This filtered query is submitted to the metadata server. At this point, the server may answer the query, or it may be necessary to poll other distributed metadata servers for information. If the information is not entirely available at the queried server, the server knows to query the servers that are associated with the organizations identified by the database search.

Various standard protocols can be used to communicate between servers and clinical systems, and to format data. For Internet communications generally, hypertext transmission protocol (HTTP) is important. With HTTP, a client computer specifies a uniform resource locator (URL) to access services and retrieve documents. This request is transmitted via HTTP to the server computer that can process the request and return a document as a “web page”. Web pages are typically defined using hypertext markup language (HTML). The extended markup language (XML) can also be used. While HTML provides a standard set of tags that describe the contents of a web page and how it should be displayed, XML provides a standard means of describing any content through the use of user defined tags. The context and meaning of the XML tags is specified through the use of document type definitions (DTD's).

Additionally, Java, a well-known, standard, scripted computer language provides many standard interfaces that can be used in conjunction with XML and HTTP. In particular, some embodiments of the invention use Java remote method invocation (RMI). RMI is a standard Java mechanism for accessing the services or methods of objects that are located on distributed machines.

An additional set of standards that is important to providing the type of information and function necessary to access clinical information comes from the Object Management Group's (OMG) Common Object Request Broker Architecture (CORBA) and CORBAMed standards. CORBA is the OMG's answer to the need for interoperability among the rapidly proliferating number of hardware and software products available. CORBA allows applications to communicate with one another no matter where they are located or who has designed them. CORBA 1.1 was introduced in 1991 by Object Management Group (OMG) and defined the interface definition language (IDL) and the application programming interfaces (API's) that enable client/server object interaction within a specific implementation of an object request broker (ORB). CORBA 2.0, adopted in December of 1994, defines true interoperability by specifying how ORB's from different vendors can inter-operate. Both CORBA 1.1 and CORBA 2.0 are available from the Object Management Group, 250 First Avenue, Suite 201, Needham, Mass., 02494, and are incorporated herein by reference. CORBAMed defines standardized interfaces to many health care object oriented services,” across most usual platforms. CORBAMed Roadmap Version 1.0b and a preliminary version of the CORBAMed Toolkit Version 2.0 are available from the Object Management Group and are incorporated herein by reference. The Internet Inter-ORB Protocol (IIOP) refers to a standard protocol for communicating between object request brokers (ORBs) over the Internet. An object request broker is utilized with Java RMI to manage access to remote objects.

In one embodiment, when a provider queries the exchange server, the server initially searches its own databases. The server will concurrently start parallel searches at the exchange servers associated with the other selected organizations. The request for information includes the requesting provider's secure identifier. The exchange servers communicate with each other using the Internet inter-ORB protocol (IIOP). Each server builds a list of clinical locator records that is then compared against a trust policy using a resource access description service (RADS).

In the context of the exchange, the RADS is used to both capture business policy regarding data and also consent that is granted by patients for use of the data. The RADS receives policy and consent information in XML format. This information is parsed and a policy record is created. Any given piece of information can have multiple policies applied to it. When a request for information comes into the exchange, RADS is invoked to evaluate all of the policies that have been applied to the data. This service can apply and evaluate a policy to the data element and method level of detail.

The policies capture the role or roles that are allowed to view/access data, and the time period that the roles are allowed to view the data in. Policies may also be applied to individuals such as the principal health care provider of the patient or to lists of individuals (the health care providers directly involved in the care of the patient). The policies can also apply to a list of attributes about a provider to determine whether the provider has rights to access the data.

Each server returns a list of records to the requesting exchange server. These records have passed the policy evaluation. This list of records is sorted based on the parameters submitted by the provider. Each locator record includes a description of the type of records; the parameters needed to access it, and information on how to access the record. If the information is unavailable as an online record, the organizational information necessary to call or fax requests is presented. If the information is available online, a URL is part of the locator record. By following this URL, a request that is properly formatted to fit that URL is submitted, asking for the clinical information. The information is retrieved from the foreign system and returned in a standard XML document format. These documents are mapped to Health Level 7 (HL7) transaction profiles. HL7 refers to the highest level of the International Standards Organization's Open System Interconnect (OSI) model. HL7 provides for the management and integration of data that support clinical patient care and the management and delivery of health care services. It is a well-known standard promulgated by Health Level Seven, Inc., 3300 Washtenaw Avenue, Suite 227, Ann Arbor, Mich. 48104, and is incorporated herein by reference.

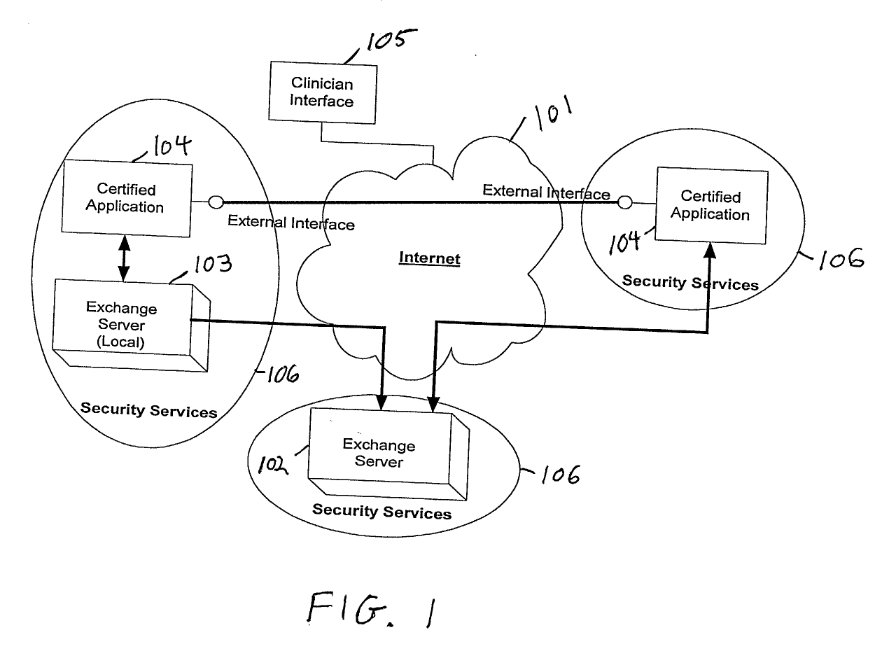

FIG. 1 describes one embodiment of the meta-architecture of the system of the present invention. The Internet, 101, provides basic connectivity between the other components, except where they are on a local area network. The exchange servers (or “metadata servers”) provide several services such as patient, provider and organization correlation, locator services, security services and accessibility services. The exchange servers provide a correlation of patient demographic and locator information for the entire community. Additionally, any or all of the services may be implemented at any of the provider organizations. The exchange servers provide a number of services aimed at facilitating the exchange of information between participants. A main exchange server, 102, is shared by the community. This server is best described as the community's root domain server. Any organization may implement a metadata server in the “local” mode as well. Server 103 is a local server. Local server 103 is a master server for the organization where such a server resides and that server is subordinate to the root domain server 102.

Certified applications, 104, provide clinical and administrative purpose to the exchange servers by pushing and pulling data from one another and presenting it to users. Certified applications will be able to exchange information directly through standardized information exchange formats and communication protocols. Such applications are “certified” to be compliant with such protocols. Certified applications are a “distributed” component of the system. Each provider organization will maintain:

Local clinical and administrative record systems (under control of participating organizations, but connected to the infrastructure).

Local repositories of clinical records (these will vary in type and quality). These are the data stores for the systems above, plus paper records.

Bridging and translation applications where local systems do not have connectivity and do not have records and metadata in a standard format.

Standard interfaces are used to aid in the interchange of information. These interfaces include standard interfaces that participants can use as interfaces for updating metadata. In the embodiment of FIG. 1, a clinical interface, 105, is also provided for secure access from outside the participating organizations. Security services, 106, encapsulate servers and applications to prevent unauthorized access to clinical information. These security services will be described in further detail below.

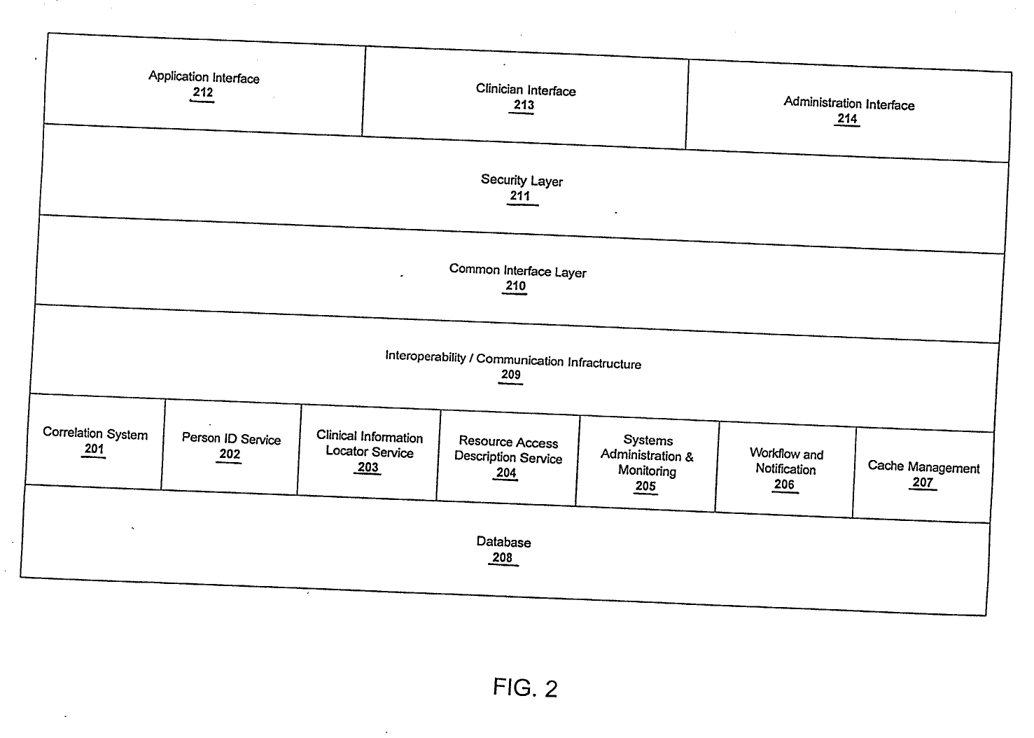

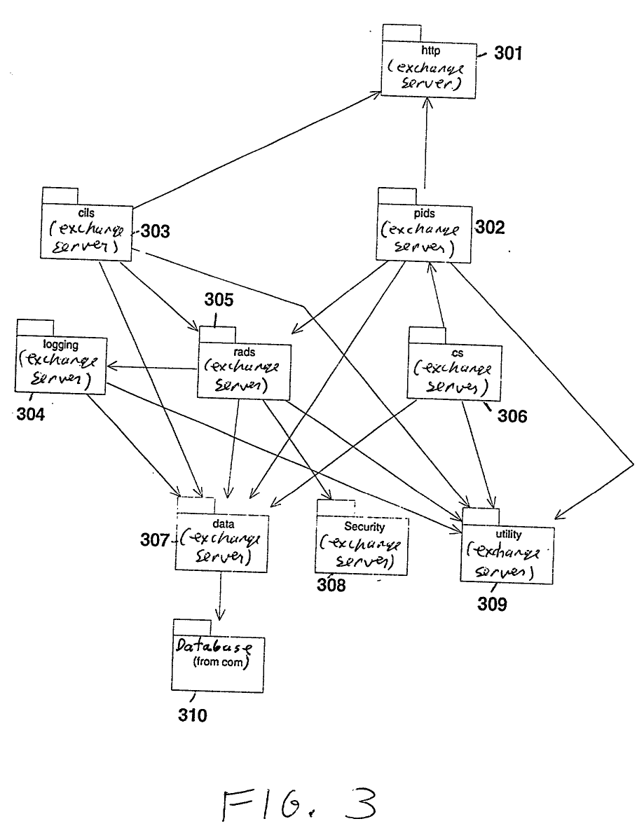

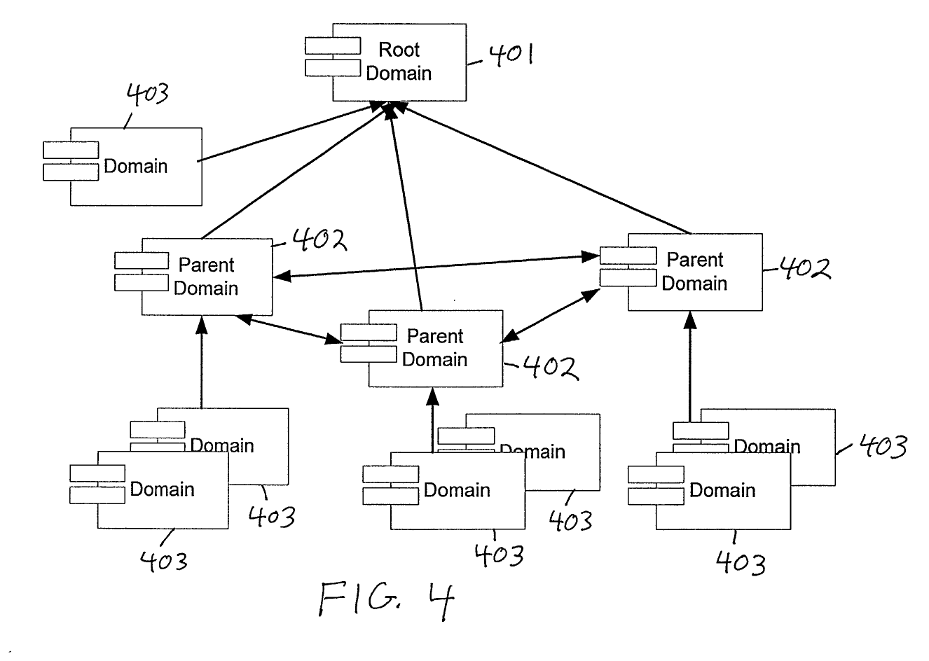

FIG. 2 illustrates the service layers of the exchange server architecture. The exchange server is a suite of components that work together. The exchange server acts primarily by providing information about how an exchange of information should take place: where the information is, what access is permitted, how the information is identified, what format is used. In this manner, the exchange server provides both function and information.

FIG. 2 shows a layered view of the component packages that make up the metadata server. The person identification service (PIDS), 202, provides an interface for accessing a federated correlation of patient ID's across the entire community. This service uses encapsulated components with standard interfaces (e.g., an RMI/IIOP implementation based on the CORBAMed specifications). The PID service is capable of performing queries and updates both on a local exchange server and federated across multiple servers via its standardized communications and object request protocols. Correlation System, 201, provides the logic and capabilities to correlate persons based on demographic, biometric and other types of data. Once the correlation has been made, a universal person object is created and/or updated and written into the database layer 208. This database layer is also an important store of data used in performing the correlations. Once the patient has been identified, a search for their information can be traversed. The clinical information locator service, 203, performs this service, searching across domains to find clinical information associated with any given person. The service has the intelligence built in to know how to query each individual provider with the appropriate patient ID. The security services, 211, clinical information locator service 203, and resource access description service (RADS) 204, work together to determine what locator information can/will be returned to the person identified as the requestor.

The security services can provide all of the functionality required government regulations, national laws, and industry standards. For example, in the United States, the Health Insurance Portability and Accountability Act of 1996 (HIPAA) delegates to the United States Department of Health and Human Services the authority to mandate the use of standards for the electronic exchange of health care data. The U.S. National Institute of Standards and Technology (NIST) also establishes standards for the secure exchange of information. Some of the other features that are provided by this module include:

Authentication and Access Control including:

Entity and role-based access control

Login and session management and logout

Authentication and digital signatures

Unique User Identification

Support for biometric identification

Context-based, role-based, and user-based access control Logging, Auditing and Notification including:

Accurate and current security incident procedures that document instructions for reporting and handling security breaches

Notification of data access to appropriate individuals, including patients

Audit trails

Services for managing and supporting patient informed consent

Reporting interfaces and functions. Data integrity controls, including:

Encryption/decryption of information stored and transmitted by the exchange server

Message authentication

Additionally, the actual servers involved in exchanging information according to one embodiment of the invention can implement physical security measures to ensure the safe operation and integrity of the systems. Physical security measures include such actions as placing the server in a locked room or a room with access controlled by a touchpad or cipher-lock. In another context, physical security measures include safeguarding the system from the outside environment with climate controls, surge protection, backup power supplies, and in some cases, seismic mounting.

The resource access decision services, 204, coordinate with the security services to determine what access will be allowed based on roles and identities. The RADS evaluates a policy that includes patient consent information to determine what information, if any is available to the provider who is making the request.

In one embodiment, a clinician interface, 213, allows direct interaction and query of the metadata server. This interface can provide instant access to information (such as a summary of all of the providers that a patient has seen) without actually accessing the detailed clinical record. The clinician user interface must also coordinate with the security services to determine what access will be allowed, based on roles and identities.

The system administration and monitoring module, 205, handles the following functions:

Local administrative interfaces that have been certified

Utilities for administration, update and editing of metadata

Utilities for initial population of metadata

Utilities for archive and purge of metadata

Notification services

Traffic metering

Project administrative interface

The workflow and notification module, 206, will provide the functionality described above for controlling routing and timing transactions between organizations.

Some of the information stored on the metadata server is cached to improve performance in one embodiment of the invention. A cache management service, 207, handles this function. The cached information is synchronized with information from a certified application in one or more fashions. These include real-time queries, polling via broadcast (based on a set bit or “dirty flag”) or time and use-based caching algorithms. Caching and retrieval mechanisms may be used to support such transactions as emergency events, where health care providers can poll information and cache it on a local metadata server for faster availability.

Application interface 212 of FIG. 2 provides an interface to user level applications. Administration interface 214 provides an interface to maintain and update the metadata server. Common interface layers 210 ties these interface modules and the clinician interface module into the rest of the architecture. Interoperability and communication infrastructure 209 provides services to interface to the Internet or any other networks used by the server to exchange information.

FIG. 3 illustrates the subsystem layers of the exchange server in one embodiment of the invention. The topmost layer of the system is the user interface (UI), not shown. Multiple UI's may exist to the exchange server. These can be implemented in any number of languages and using any number of common implementation techniques. These interfaces can be customized to differentiate one system from another. Alternatively, a common UI may be accessed as an Internet portal. XML is used as a common unifying language between the application services of the exchange server and the user interface and calling applications that are connected to the exchange server. Use of XML in this way creates a loose coupling of applications. The user will connect to the exchange server by submitting each request as an XML document that contains the request and the request parameters. The XML document is received by a servlet encompassed in HTTP package 301. This servlet parses the XML into corresponding objects that are then used in the lower level service layers.

Requests can be submitted to PIDS package 302 or a clinical information locator service (CILS) package, 303. The former will process requests for looking up and correlating patients, while the latter will process requests for clinical information about a specific patient, a group of patients or, in non-patient identifiable form, requests for information about a certain type of clinical record.

In either case requests for service are sent to the RADS package, 305, which evaluates whether the user has the appropriate rights and responsibilities to access the data. The RADS package also makes use of the security package, 308, which handles such functions as identifying the requestor and encrypting/decrypting data which is transmitted. Additionally the RADS package makes use of logging package 304 to log all requests for services as they are received. This information includes not only who is making the request and when, but also which data elements are being sought and the methods being requested. The PIDS package also makes use of the correlation system (CS) package, 306, which handles correlation of patients based on demographic data and search and retrieval for the correlated patients.

Packages 302, 303, 304, 305 and 306 make use of the data package, 307, to access the data used by the service layers. The data package provides abstract data objects that hide the specific implementations of the database layer, allowing the exchange to be vendor neutral as regards an underlying database. The data package relies on an underlying database package, 310, which provides database specific functions. It should be noted that in this example embodiment all packages shown reside, at least logically, in or on the exchange server, except for the database package, which may be remote and accessed over a communications link.

FIG. 4 describes the modified hierarchical federation approach used by the exchange server according to one embodiment of the invention. In this approach, each provider (who wishes to) maintains their own domain of information: patient, provider and organization indices. However, one metadata server acts as a “root domain” for the information. An information service provider may maintain this root domain server as part of its service. A health care provider can opt to utilize the root metadata server as its domain, rather than maintaining domain information of their own. In this approach, the root metadata server takes an active role in receiving and requesting information from the domains below it. The components of the metadata server will be operated in both local and centralized modes. Organizations may choose to maintain one or more metadata servers or they may choose to implement components of the service. Participating organizations or their agents will operate and maintain the local servers. The shared components, whether centralized or distributed, operate in a virtually centralized manner, maintaining a consistent and coordinated image of the overall state, with or without true centralization.

The system supports multiple configurations depending upon the metadata server requirements to support local copies of the metadata. The component-based architecture allows the provider to select some or all of the services; for instance, both the patient identification and locator services, one of the services, or neither. An entire metadata server can be implemented for a provider organization or an organization can make use of metadata from a community domain server. If a metadata server is implemented for an organization, it will become a child domain of the community domain. An organization may choose to implement a part of the metadata server (for instance, the person ID service but no other directory services). This arrangement might be used where the organization uses relatively few relationships and enhanced person ID correlation performance is desired. In general, the size of the health care organization and number of providers or patients associated with it determines which components to locally install. FIG. 4 illustrates one example of how the above-described arrangement might work. Server 401 is the root domain server. Servers 402 are community servers as described above, also called “parent domain” servers. Servers 403 are local servers.

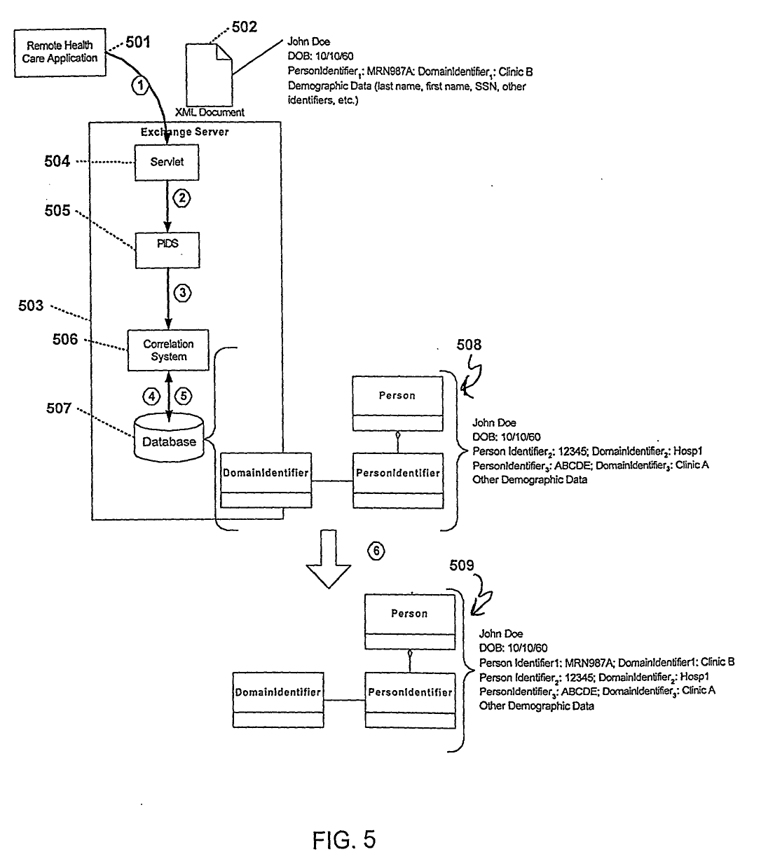

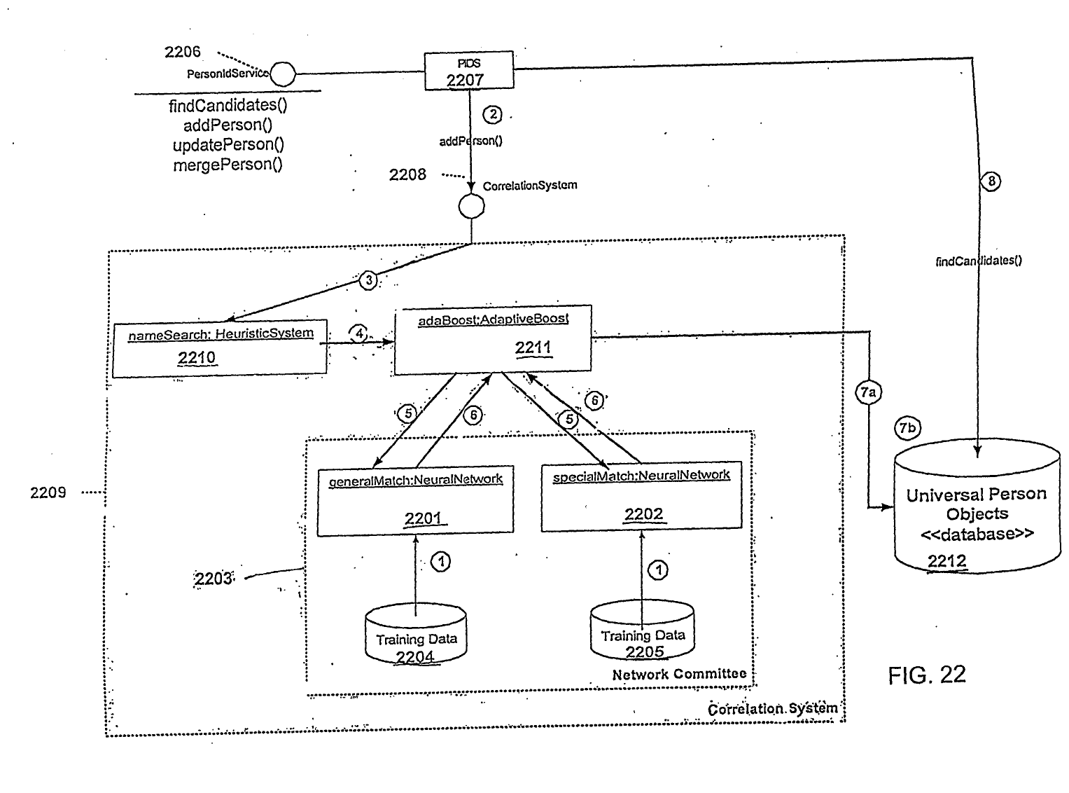

FIG. 5 is a schematic that describes the flow information and processing required to generate the information that is central to the exchange server function in one embodiment of the invention. Once generated, this information is used to find where a patient has been seen and where clinical information might be found. By querying these organizations, the health care provider can find available information about the patient. To start, metadata is sent from a remote eHealth application system or clinical repository, 501, to the exchange server's metadata store at step 1 in the form of an XML Document, 502. This information may be sent as a batch transaction or through the function of either a push agent or a pull agent. These agents are further described in relation to FIGS. 18 and 19. The information sent in this transaction represents the loose coupling of the application 501 and the exchange server 503. Contained within this document are such attributes as the name of the person, date of birth and other demographic data and various identifiers and the identity of the authority that has assigned the identifier. The information is sent to the servlet, 504, which is responsible for parsing the XML and then submitting the information in step 2 to the PIDS, 505. The PIDS supplies standard interfaces for accepting new patient information. Subsequently, the PIDS submits the data to the correlation system, 506, in step 3. Operation 3 signals the correlation system, 506, to operate on the new data and search for potential matches on the patient demographic data. The method by which this happens is described further in reference to FIG. 22. At step 4, the correlation system queries the database, 507 searching for records that it will consider for a match. Once appropriate matches have been identified, a universal person object is determined, that is, accessed or created in the database, at step 5, along with the patient ID and organization ID from the originating data source.

Detail of the database update is illustrated by showing a part, 508, of the universal patient object hierarchy and the values stored in the database before the match has been made. At step 6, the match has been performed and the universal patient object is updated with the new data as shown at 509.

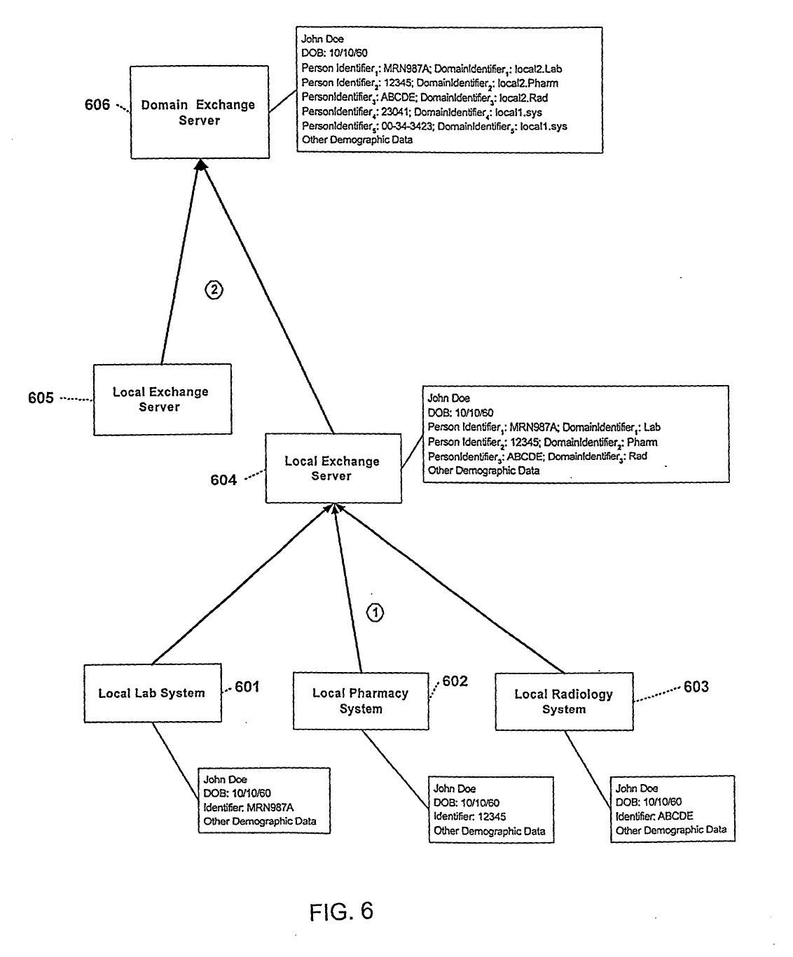

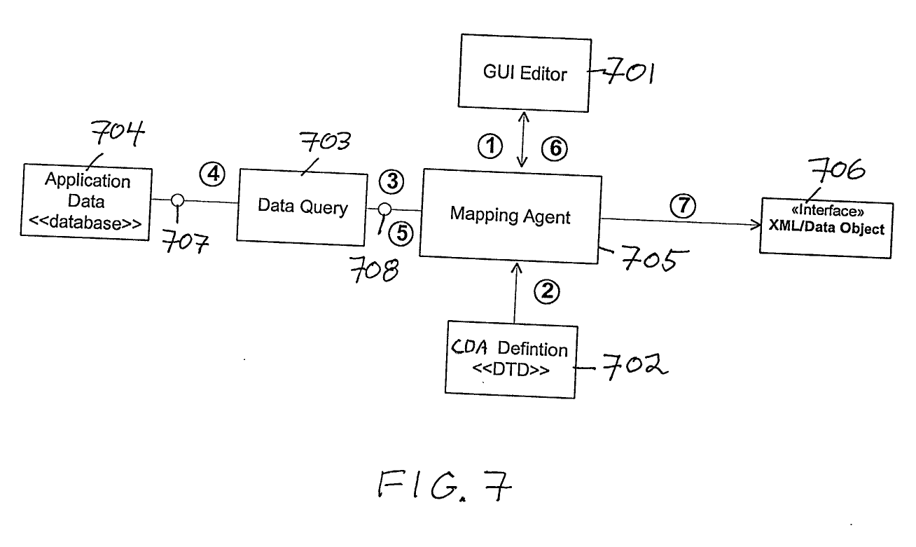

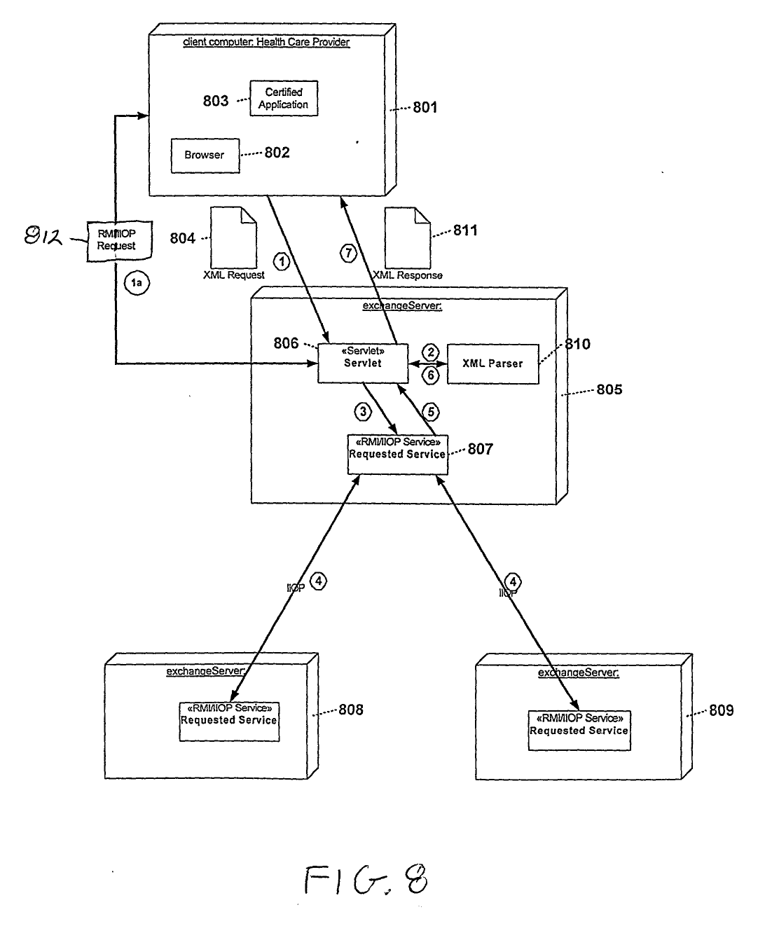

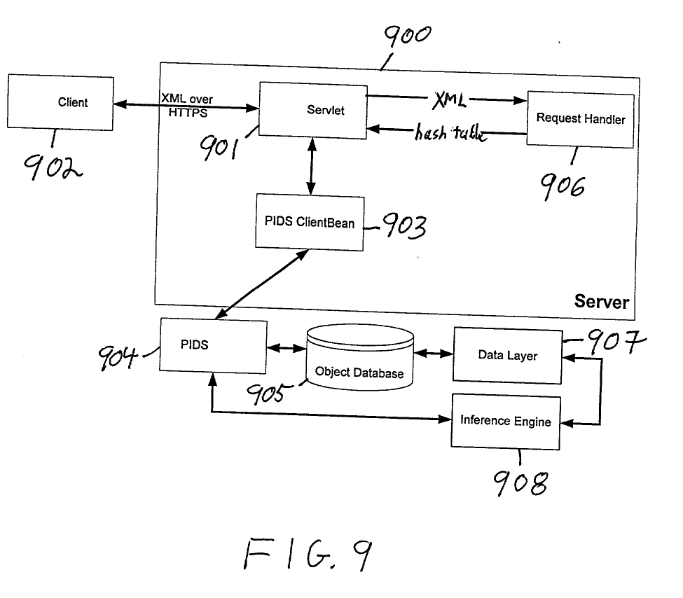

FIG. 6 extends the functionality described above to allow federation of identifiers across multiple domains. In this schema, a local exchange server, 604, correlates patients across a number of systems within a local domain. At step 1 information is sent to the local server by a clinical system such as a pharmacy system, 601, a laboratory system, 602, or a radiology system, 603. A local universal person object is created and then forwarded to the parent, the domain exchange server, 606, in its hierarchy. The parent can receive data from multiple local exchange servers such as shown at 605. The parent now knows that it can query local exchange server 604 and ask for information about a patient and the local exchange server will subsequently query each of its subsystems to find records for the patient.

FIG. 7 describes a system and method by which the interfaces necessary for open interchange of clinical data as well as exchange of metadata can be created. This method utilizes a utility called a “mapper utility”. The primary function of the utility is to provide a design-time tool that creates a run-time object that can be invoked to respond to queries from outside sources. The interface is created by first invoking a GUI editor, 701, at step 1. From the editor, a user can select a DTD to import or create one from scratch at step 2. Use of the DTD is especially powerful as updates for a patient record format are distributed. The Clinical Document Architecture (CDA), published by HL7, Inc., formerly known as the Patient Record Architecture (PRA), as an example, is an evolving standard for patient records. A user who is keeping records according to this standard can import a new version of the CDA DTD, 702, as the standard changes, and simply update their data mapping to the elements of the DTD at step 2.

The editor allows the user to create a SQL query, 703, or use an existing query or stored procedure to access actual clinical data at step 3. The query is validated against the application database, 704, at step 4 and the database fields from the query are loaded into the mapping agent, 705, at step 5. The user now simply maps the database field to the XML element using the editor at step 6. When complete, the user generates the data object, 706, at step 7. This object (an enterprise Java bean) contains both function and data elements and can respond to various parameters. Note that interfaces 707 and 708 are external interfaces.

FIG. 8 describes the system and method that allows a health care provider system to make requests of an exchange server according to one embodiment of the invention. This server can be local to their system, the root domain server, or a partner provider's server. Client computer system 801 contains a browser, 802, or a certified application, 803, or both. The request, 804 and/or 812, is sent at step 1 or 1a. A request to the server can be submitted in two ways—either as an RMI/IIOP request to one of the servers RMI interfaces, or formatted as an XML document that is sent via Secure Hypertext Transfer Protocol (HTTPS) as a POST transaction. In general, the lafter method will be used to loosely couple multiple distributed applications.

HTTPS is a well-known World Wide Web protocol developed by Netscape Communications Corporation. HTTPS uses various encryption suites to encrypt and decrypt user page requests as well as the pages that are returned by a Web server. HTTPS uses Secure Socket Layer (SSL) as its transport layer. SSL is discussed in the standard Request for Comments (RFC) 2246, published by the Internet Engineering Task Force (IETF) in January, 1999, where it is referred to as the Transport Layer Security (TLS).

At step 1, the parameters of the request are wrapped in XML to provide a structured, rich set of parameters that can be included with the request. Alternatively, at step 1a, the request can be direct via an IIOP call from the certified application if the remote system supports this technology. The server, 805, provides an interface to the HTTP request as a servlet, 806. At step 2 the servlet passes the XML document to XML parser 810 that returns an object instance of the request and its parameters. The servlet, at step 3, then instantiates the required service, 807, implemented in one embodiment as an RMI/IIOP service. At this point, the RMI/IIOP service may have the information locally to provide a response or it may need to query other exchange servers, 808 and/or 809. The RMI/IIOP service uses a discovery function of a trader to locate the remote servers. At step 4, the exchange domain server queries other exchange servers. This query is a straightforward IIOP service request. At step 5 the response from the service is returned to the servlet, 806, which will then uses the XML parser, 810 at step 6 to format the returned objects into an XML response document, 811, which is returned to the provider system.

FIG. 9 supplies more detail about an embodiment where a method and system for uses XML as the language for transporting data and requesting services from the exchange server, 900. XML is transmitted over HTTPS to a servlet, 901, from a client, 902. The single serviet is given as an example in the diagram. Additional servlets can exist for processing location information requests as well. A PIDS client bean, 903, connects via IIOP to the PIDS, 904. The PIDS is connected to the object database, 905, that stores the actual metadata. XML documents can be easily transferred over HTTP via the POST method of a Java Server Page (JSP) page or servlet. Java Server Pages provide for controlling the content or appearance of Web pages.

In FIG. 9, client 902 and servlet 901 pass XML documents to each other via an HTTP POST. The client connects to the servlet and sends an XML document via the POST method. The client obtains the URL for the servlet from the argument list, opens a URL connection, obtains the output stream from the connection, and prints the XML document to the output stream. The servlet processes the XML sent from the client and returns the results in another XML document. The client reads the resulting XML document from the URL connection's input stream and parses it.

Servlet 901 reads in the XML document sent from client 902. As described above, client 902 sends an XML document within the HTTP request header (the POST method). Within servlets a doPost of a buffered reader is obtained and the request is passed to a request handler object, 906, to be parsed. The doPost method is a standard method defined in for Java servlets for processing HTTP and HTTPS post operations.

A buffered reader reads text from a character-input stream, buffering characters so as to provide for the efficient reading of characters, arrays, and lines. The buffer size may be specified, or the default size may be used. In general, each read request made of a reader causes a corresponding read request to be made of the underlying character or byte stream. Buffered readers are generally wrapped around any reader whose reado operations may be costly, such as file readers and input stream readers. The hash table is a standard collection class that allows indexing and faster search and retrieval of data stored in the hash. The hash table associates a key with the value stored in it.

After processing the request, servlet 901 returns an XML document to client 902 by using a writer obtained from the HTTP response. Servlet 901 processes the request through the services of a PIDS client bean. This bean operates as a PIDS client and connects to the PIDS over IIOP. The PIDS is connected to object database 905, which stores the patient demographic data based on the HL7 standard using data layer 907 and inference engine 908.

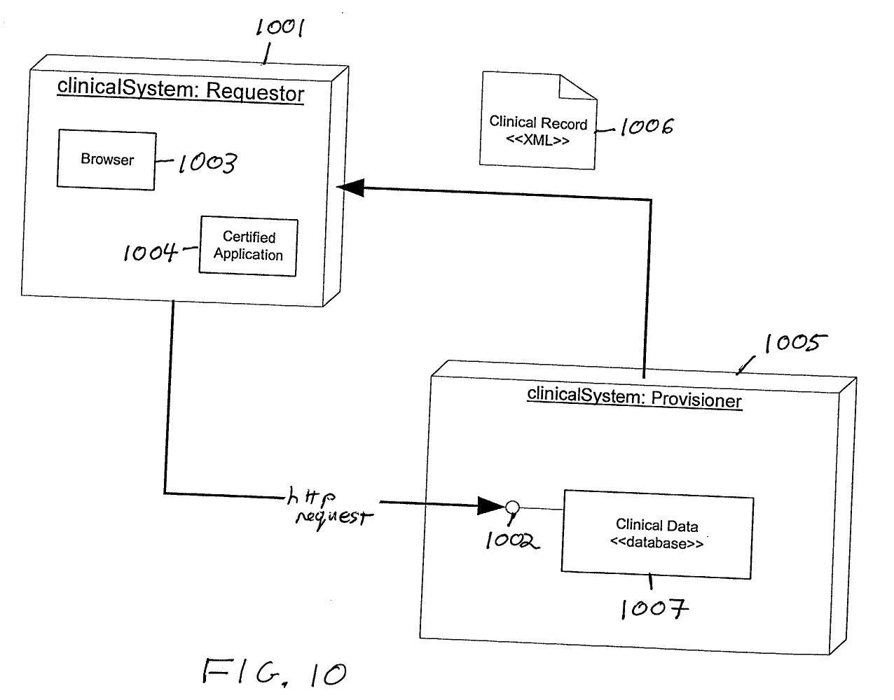

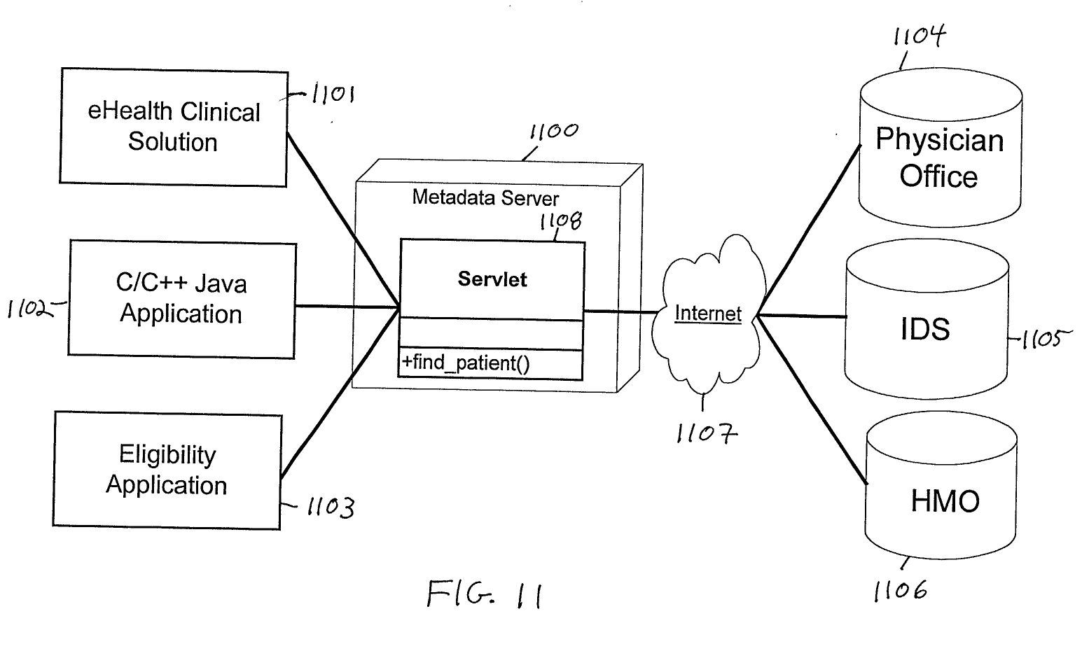

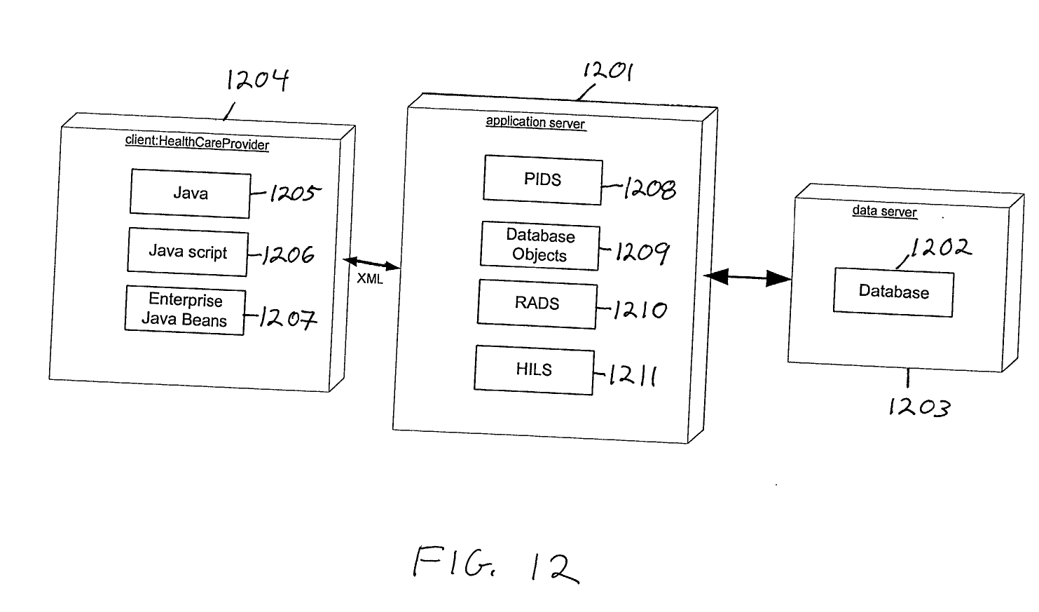

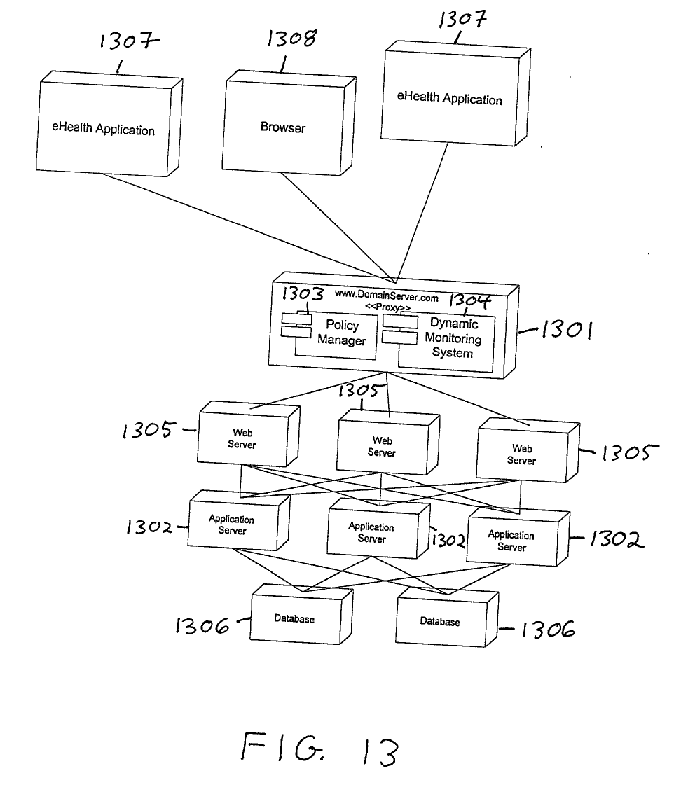

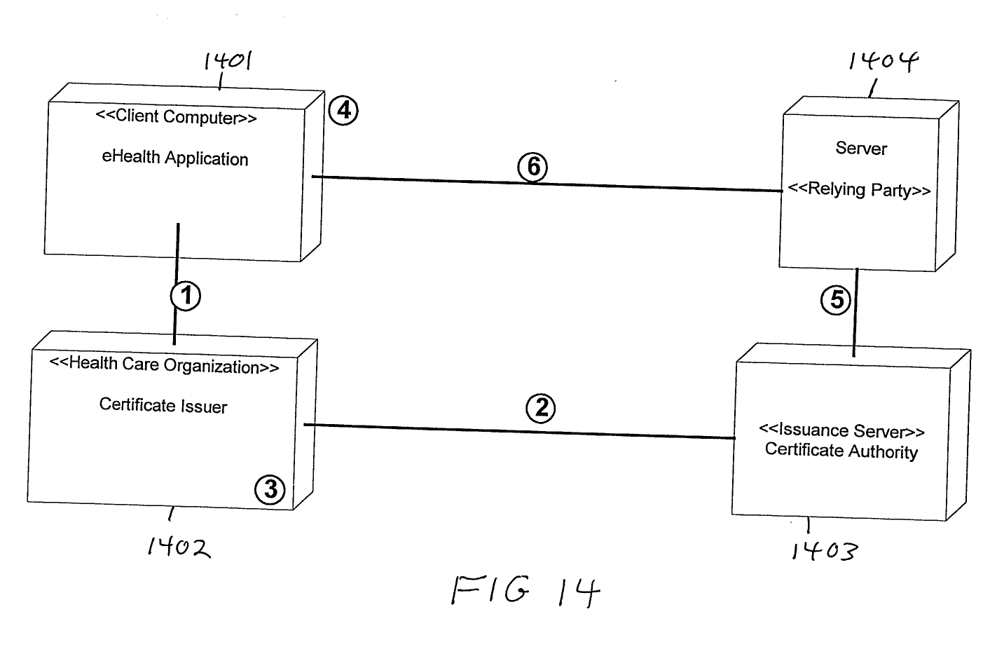

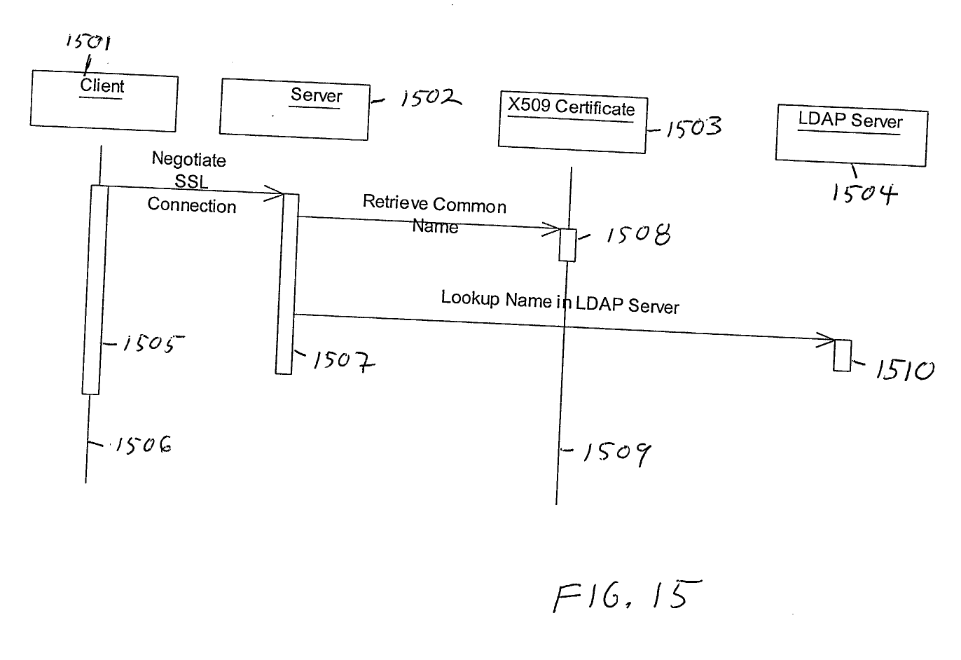

FIG. 10 describes the method in one embodiment by which clinical information is exchanged between two providers once the exchange domain server has returned information to a provider's system. The method uses HTTP requests to a known interface, 1002, on the remote system, such as one of the interfaces discussed in reference to FIG. 2. The HTTP request is sent from the requester clinical system, 1001, by either browser 1002 or certified application 1004. A clinical record 1006 is returned by the provisioner clinical system, 1005 from clinical data 1007.

FIG. 11 highlights the ability of multiple types of applications to connect to the metadata server to access its services. In one embodiment of the invention, an eHealth clinical solution, 1101, based on web technologies can access the metadata server, 1100, directly from a browser sending and receiving HTTP requests. Server 1100 includes servlets, 1108, that can perform various routines such as the fine patient routine illustrated as an example. In another embodiment, a client server application such as the C/C++ Java application 1102 or an eligibility application, 1103, can access the metadata server directly over IIOP. On the server side of the transaction, the metadata server can build its repository of metadata from a number of different organizations, such as a physician's office, 1104, an integrated delivery system (IDS), 1105, or an HMO, 1106. These services are connected to the server via the Internet, 1107. A browser is not required to drive web interactions with the exchange server. The exchange server defines the locations (URL's) of each service, input parameters to be submitted (via GET or POST methods) to each service, and output parameters to be returned by each service. Service definitions are dynamically interpreted and can thus be centrally managed. Client applications are insulated from changes in service locations and data extraction methods. Developers are insulated from network programming concerns. In this manner, the services of the exchange servers can be accessed from e-health applications as a URL. Since the intra-server communications of the exchange system can be handled via IIOP, the services can also be accessed directly via CORBA if desired.

FIG. 12 illustrates how the Exchange server utilizes an application server to help develop, deploy, integrate and manage the services that are provided by the system of exchange servers such as server 1201. Databases 1202 are separated from the application and in this embodiment are stored on their own server, 1203. A health care provider system, 1204, access the server and formulates queries using Java components such as Java 1205, Java Script 1206, and enterprise Java Beans 1204. Server 1201 includes PIDS 1208, database objects 1209, RADS 1210 and a health information location services (HILS), 1211.

The health information location service provides a simple set of interfaces to access pointers to health information. Given a patient identifier, and optionally, a date range and type of record, a list of URLs is returned to the requester. The pointer data, which combines a patient id and a summary description of the type of clinical record, is the most sensitive data stored in the exchange. Due to the sensitive nature of this data, a health care provider may wish to store the data in an exchange server operated by a service provider as opposed to operating its own exchange server. The location services uses a “trader” mechanism to discover other servers and queries them for the data that is stored on the remote servers. The data is returned to the requesting server if it passes the access decision (RAD) process. HILS allows users to query based on time range, patient, practitioner, services, encounter/episodes, health conditions, facility types, symptoms, and other qualified codes.

A trader mechanism operates as follows: when a service is plugged into a network it advertises itself by publishing an object that implements the service application program interface (API). This object's implementation can work in any way the service chooses. The client finds services by looking for an object that supports the API. When the trader gets the service's published object, it will download any code it needs in order to talk to the service, thereby learning how to talk to the particular service implementation via the API. Objects move around the network to make each service, as well as the entire network of services, adaptable to new strategies used over time.

FIG. 13 illustrates the use of dynamic load balancing and load policy management to address the reliability and scalability issues according to one embodiment of the invention. Domain server 1301 and all other servers and databases below it are in the Internet server environment. Server 1301 manages this environment. The application servers, 1302 evaluate the load policy for each node to determine thresholds and load balancing. A proxy system, including a policy manager 1303 and a dynamic monitoring system 1304, provides a layer of security and a means of redirecting traffic to multiple web servers, 1305. These servers, as well as the application servers, 1302, and databases, 1306, are varied based on server size as well as the number of servers. If a node fails, its load can be reallocated to another web server. This environment is utilized by a root domain server, not necessarily by any of the other domain servers within a community. Access is provided to eHealth applications 1307 and/or a browser, 1308.

FIG. 14 looks at using an external service as an authentication mechanism for the exchange system. In this embodiment, one or a few recognized authentication services that are used for authentication as well as the chain of trust or flow of credentials. The flow of events is as follows:

The user at client computer 1401 running an eHealth application enrolls with the Certificate Authority (CA) by applying for a digital credential at step 1 at an Issuer's web site, 1402. The issuer links to an issuance server, 1403 at step 2. The user is then asked for personal and professional information (predetermined by the issuer) at step 3.

Once enrolled, the user is guided through a registration process at step 4, creating a set of personal questions to which only they would know the answers. These answers enable the user to use their digital credential from any computer system. This feature enables credentials to be used for identifying an individual rather than a computer or an organization. The exchange domain server, 1404 acts as a relying party, accepting the digital credential associated with the user. The exchange is configured to accept a digital credential. Certified applications implement much of the front-end access and pass the credential to the exchange.

As soon as the user inputs their information, the exchange server contacts the CA at step 5. If the inputs are correct, access to the exchange system is granted. In this manner, both the certified application and the exchange utilize the CA to validate the credentials through a chain of trust at step 6.

FIG. 15 describes the sequence of events that take place to validate a user against an LDAP directory in an LDAP server. LDAP is an acronym for “lightweight directory access protocol”. LDAP is a standard used in the Internet for directory queries. These directories can be public or private. After the client, 1501, has negotiated an SSL connection with an application server, 1502, the LDAP realm retrieves the user's common name from the X509 certificate, 1503, and searches the LDAP server, 1504, for that name. The LDAP realm does not verify the certificate, since that is performed by the SSL protocol. Once the user's identity has been established, the functions that they are allowed to perform can be evaluated and a session established.

In the type of sequence diagram shown in FIG. 15, all of the boxes across the top of the diagram represent programming language objects. The vertical line below each box represents the lifeline of each of the objects. A thin line such as 1506 and 1509 means that the object is not active and not even instantiated in memory. It may actually be written out (serialized) to disk or simply swapped out of memory by the operating system or virtual machine. The thick part of the line or bar such as shown at 1505, 1507, 1508, and 1510 represents the period of time when the object is active and is in memory. Additional diagrams of this type are used throughout the disclosure to illustrate embodiments of the invention.

An application server operates at the center of a multi-tier architecture. In this architecture, business logic is executed in the application server, rather than in client applications. The resulting “thin” client, three-tier architecture allows the client to manage the presentation layer (browser), the application server to manage the business logic and the back end data services manage the data. The application server serves static and dynamic web pages, and manages database access, security, and transaction services for applications.

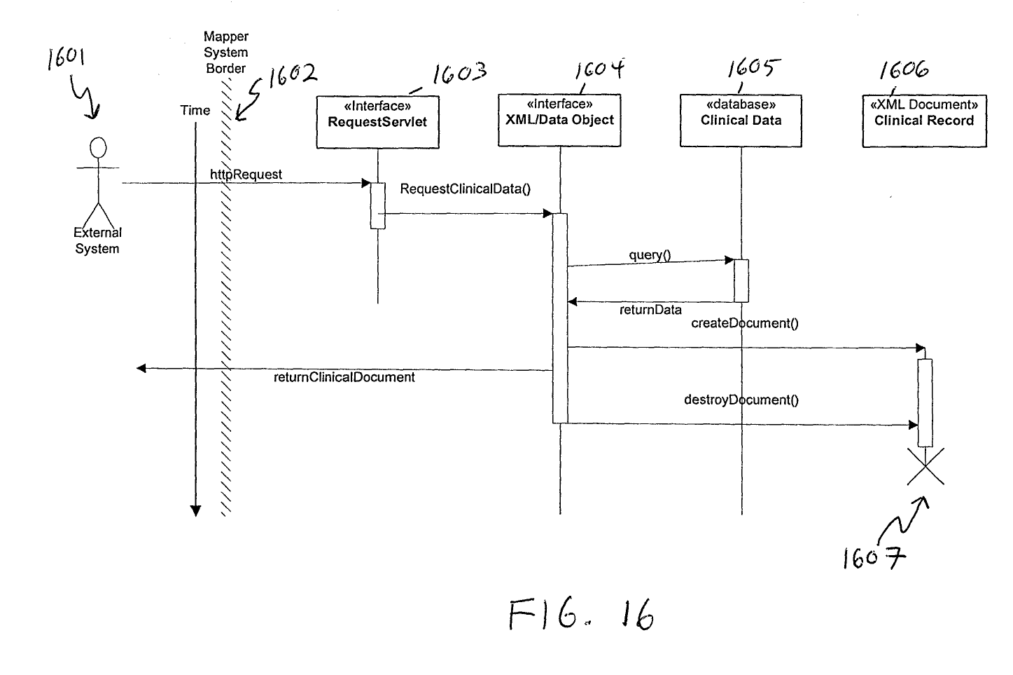

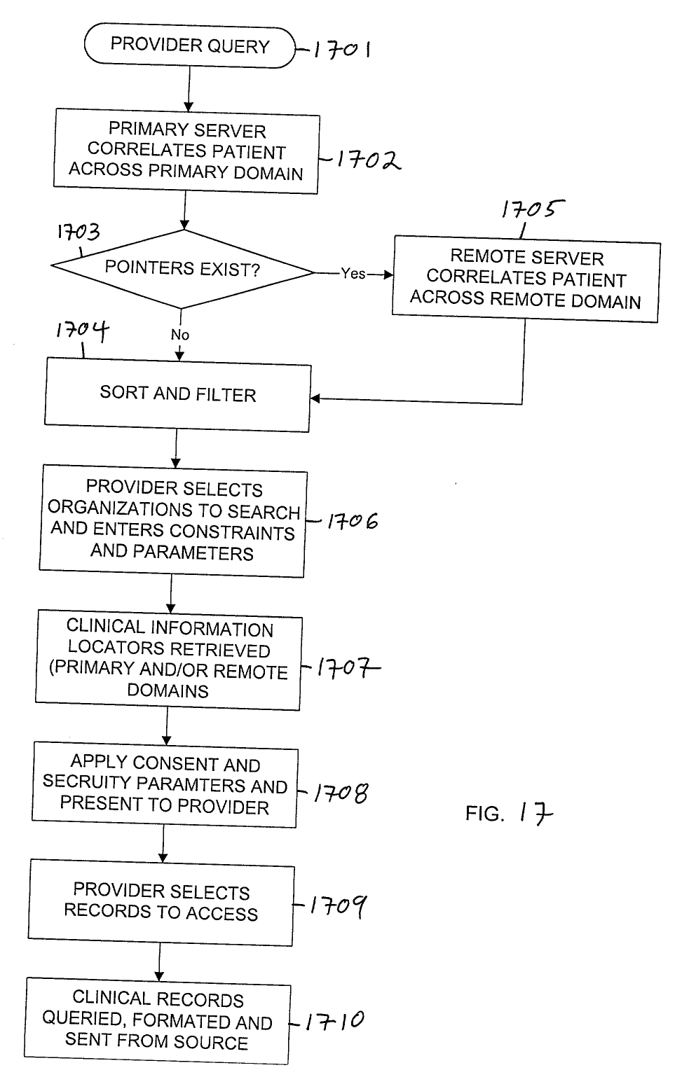

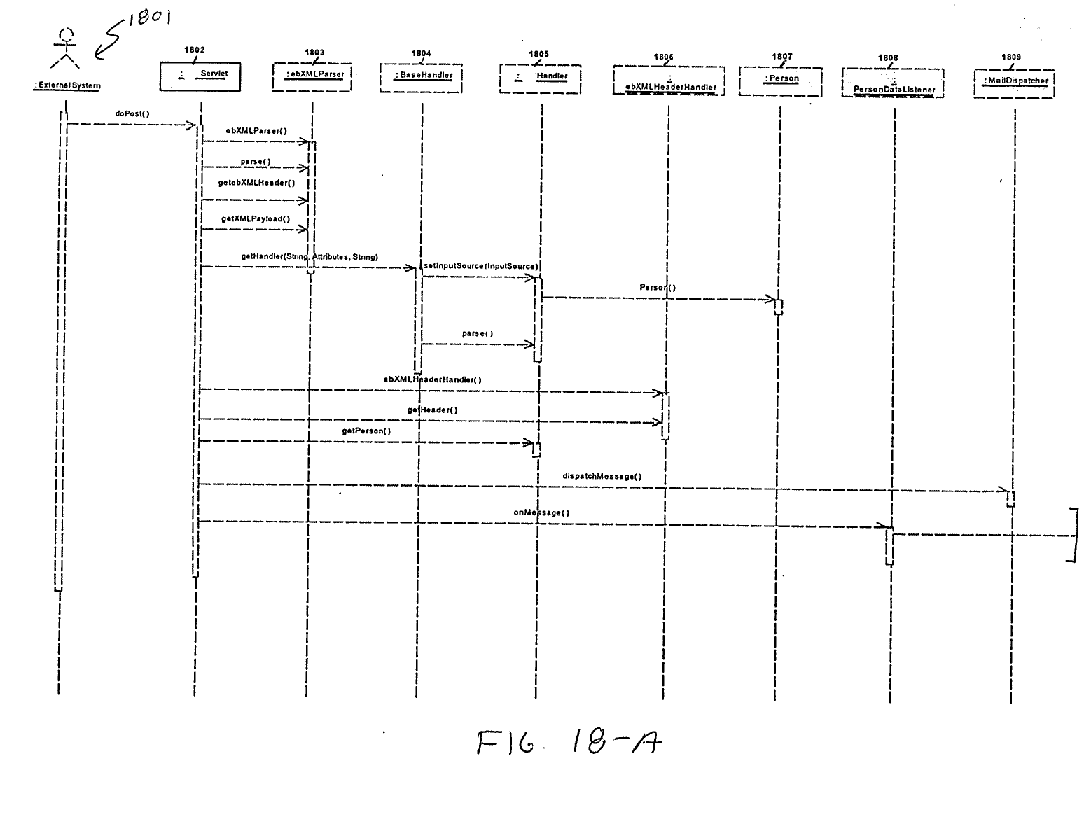

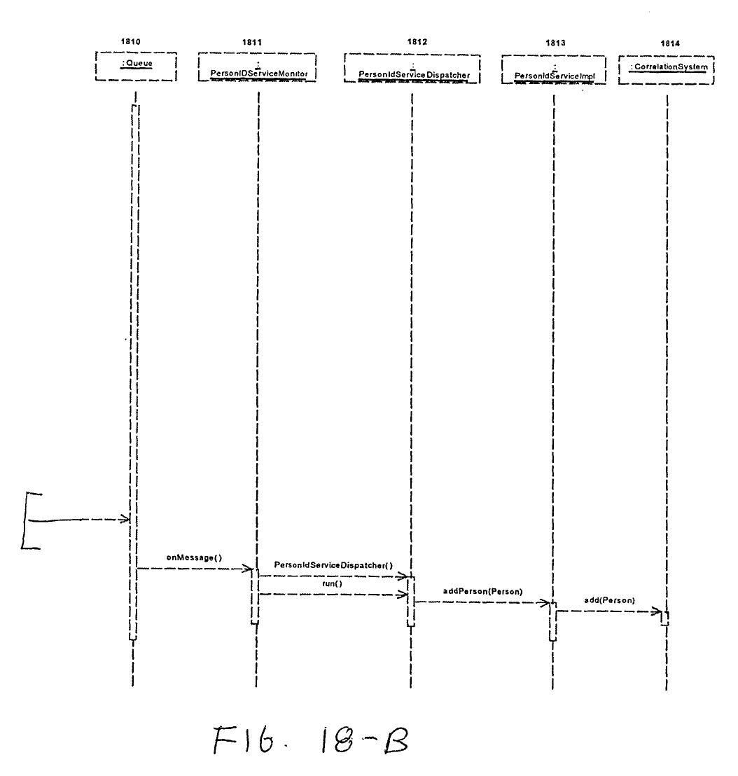

FIG. 16 describes the sequence of events that take place during run time interaction with an object created by the mapper utility according to one embodiment of the invention. An external system, 1601 initializes the sequence of events by sending an HTTP POST request to a URL. The external system is typically outside the mapper system border 1602. A JSP, servlet, or active server page (ASP), 1603, that has an embedded mapped data object (MDO), 1604, receives the request. The MDO is the runtime object created by the mapper utility. On initialization, the MDO takes the parameters passed to the JSP, and uses those as inputs to its pre-built query. The object then completes creation of the query, and sends the query to a data source, in this case a database of clinical data, 1605. When the query is returned at step, the data is formatted (based on the map) to an XML DTD created for this MDO. The MDO forwards this document to the external system over HTTP. The XML DTD's are based on the HL7 transaction profiles and are XML-based expressions of this standard. When the document is no longer being viewed on the external system, and if it is not being cached, the external copy is destroyed as shown at 1607.

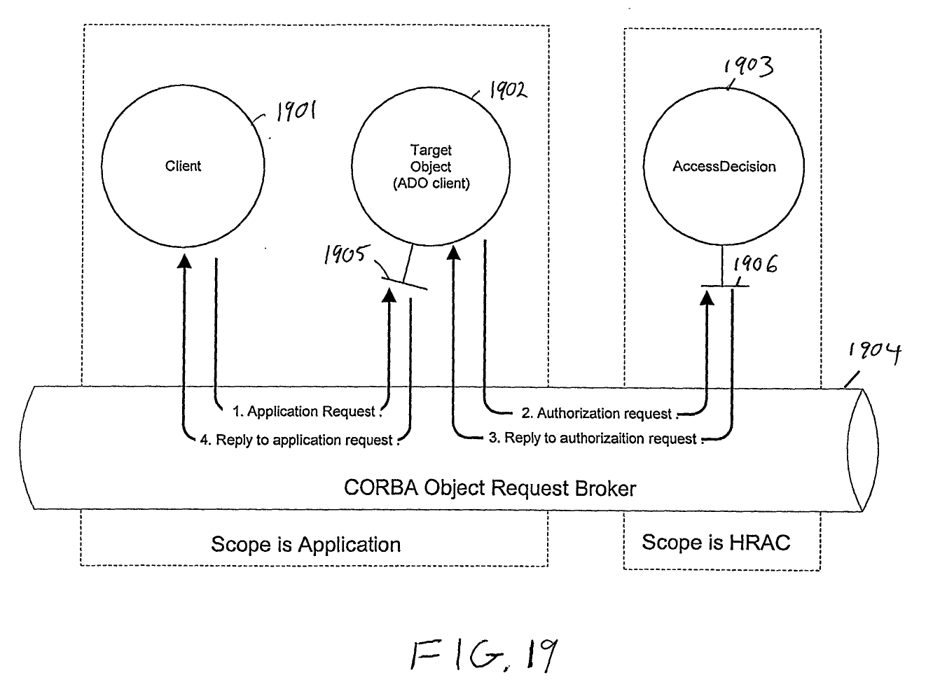

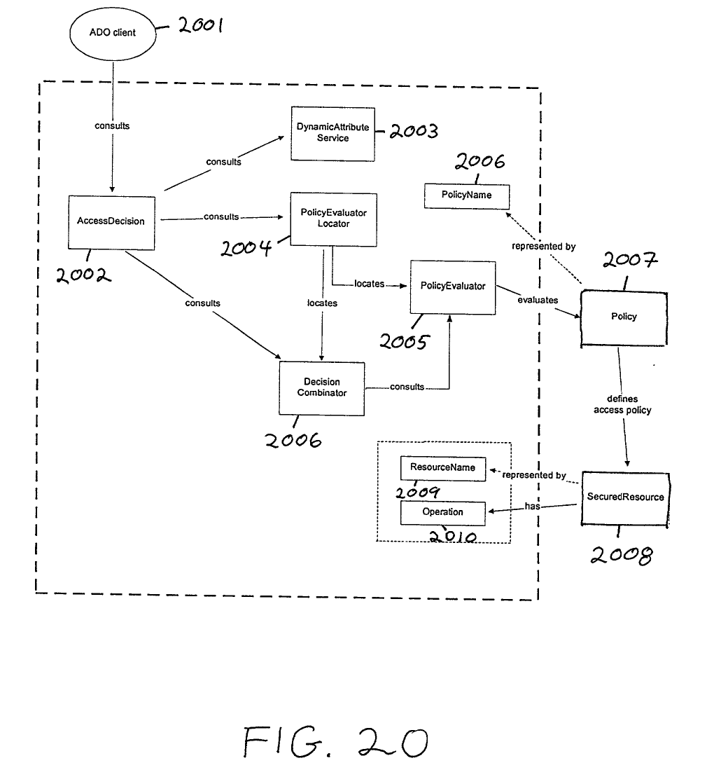

FIG. 17 is a flowchart describing the flow of events that take place in querying the exchange and subsequently asking for clinical information from a remote system. The flow of events starts when a health care provider submits a request to find information about a patient at step 1701. This request includes patient demographic data or local identifiers from the provider's local system. The exchange server receives the request, then compares the information against the cross-index that has been built by the inference engine. The request is forwarded to a PIDS identity interface and the search begins at the local server. We refer to this process as “correlating” the patient identification and it is shown as step 1702 of FIG. 17. The primary server determines whether it has references to remote exchange servers as well at step 1703. If so, this indicates that the local server has captured a global unique identifier (GUID) from another exchange server, which in turn knows more information about how the patient is identified in other domains or systems. In this case, the patient is correlated at the other server at step 1705.

In either of the above cases the information is sorted and filtered at step 1704. The provider can select which organization's information is to be viewed and what parameters are to be applied to the displayed information at step 1706. Clinical information locators are retrieved at step 1707. The information is compared against a security policy to determine whether the records about where a patient has been seen can be returned to the provider. The security policy includes patient consent parameters. The allowable information is sorted and filtered according to both the security policy and the other parameters and a list is returned to the provider at step 1708. The provider selects from the list at step 1709. At this point, the provider system is connected to the system where the records are kept, assuming the security and consent policies allow, and the records are queried, formatted, and sent from the source at step 1710.

FIG. 18 is a sequence diagram describing how an external clinical system requests service from the exchange. FIG. 18 is divided into FIGS. 18-A and 18-B for convenience. The last horizontal line on FIG. 18-A is the same line as the first horizontal line on FIG. 18-B. By “external clinical system” we mean a system used by a health care provider that is supplying data to the exchange system. The external system can also be one that requests data from the exchange. This example demonstrates the method by which the data would be sent to the exchange. The exampIe illustrates the loosely coupled nature of the exchange architecture. Loosely coupled systems do not have hard coded linkages between them, but rely instead on a communications protocols and standards to achieve their associations.

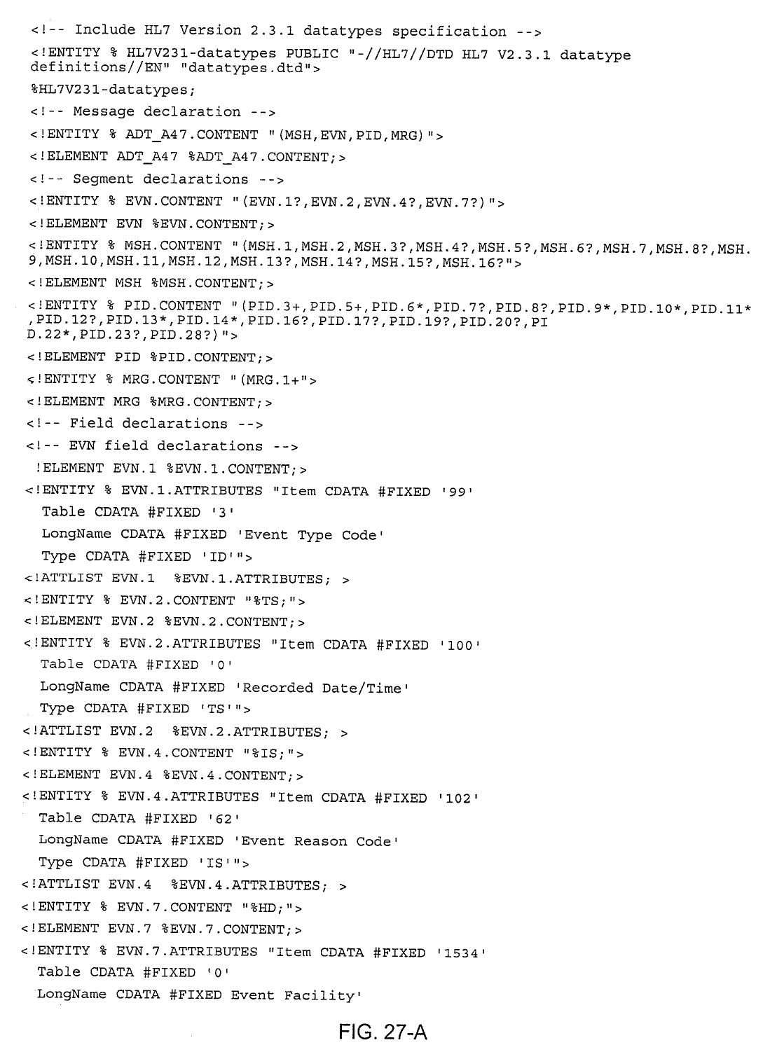

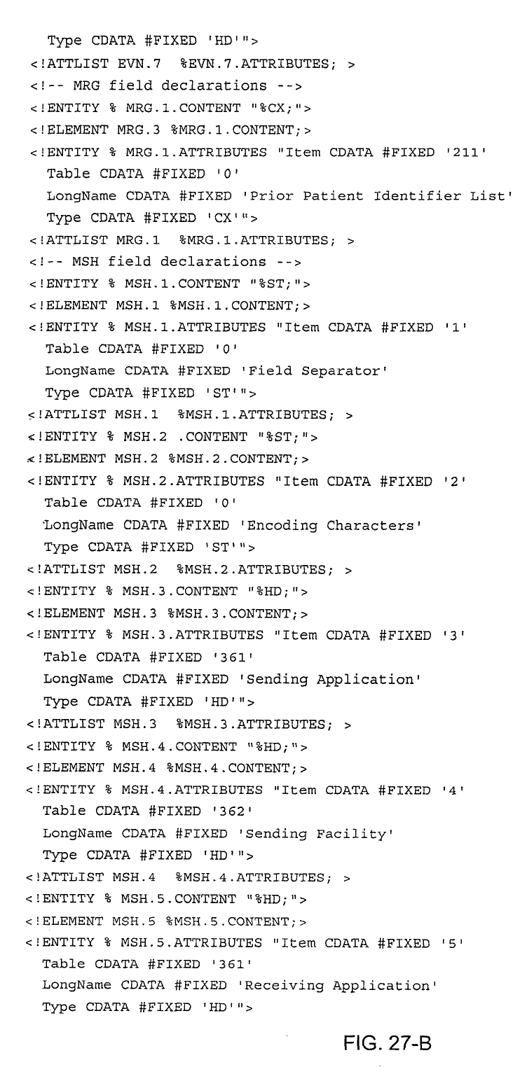

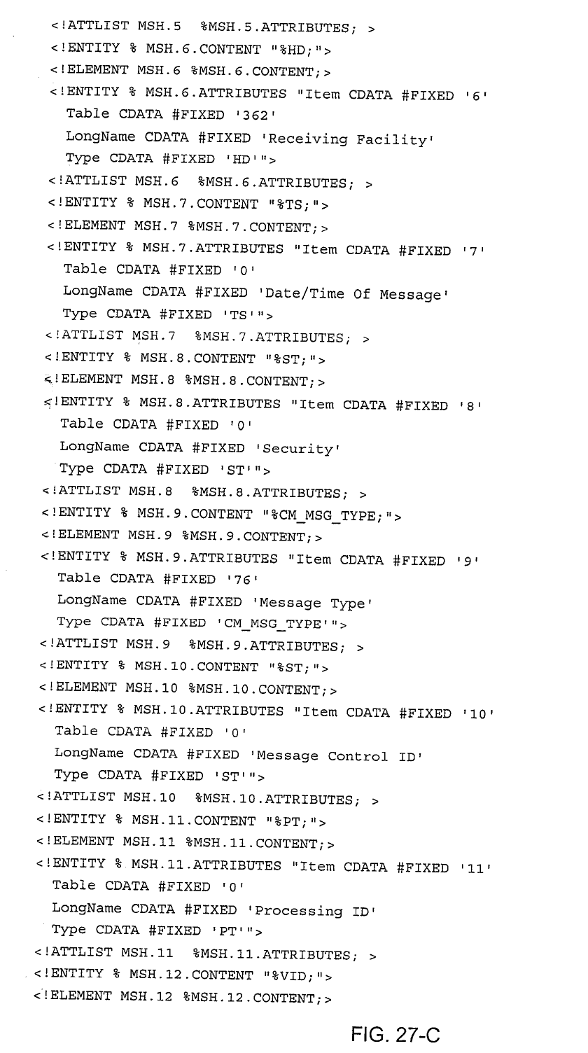

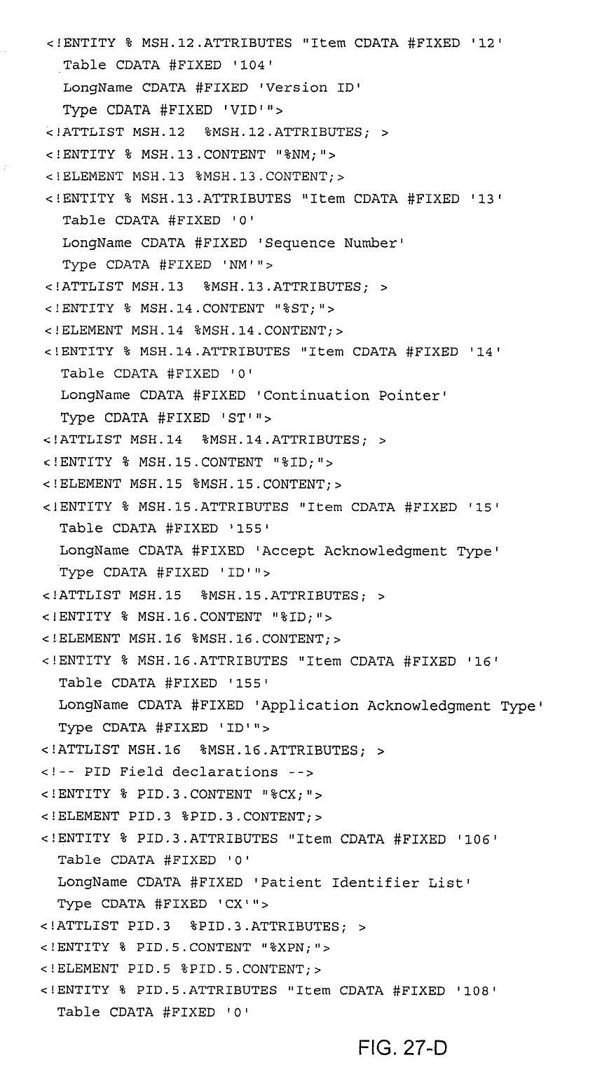

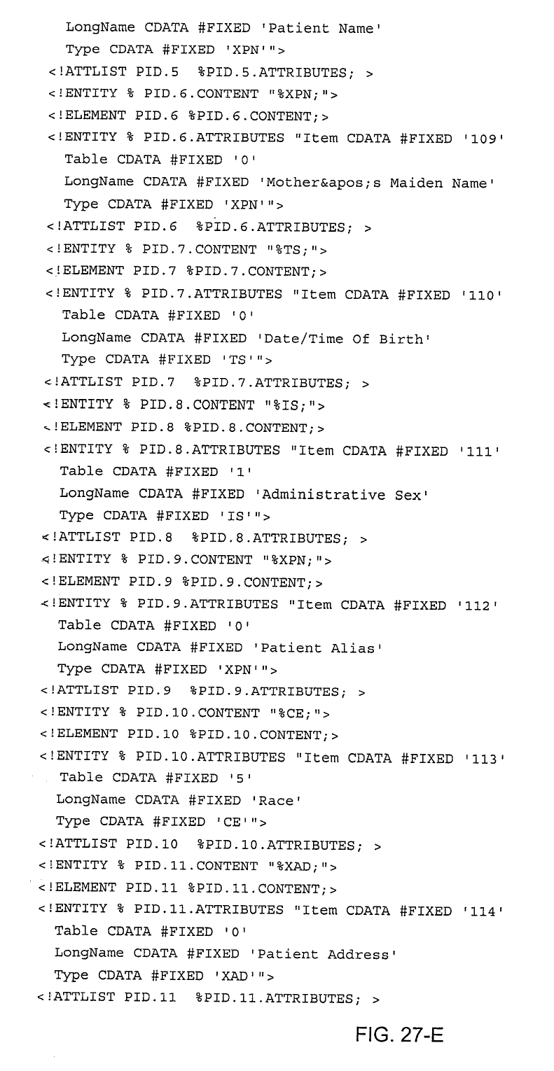

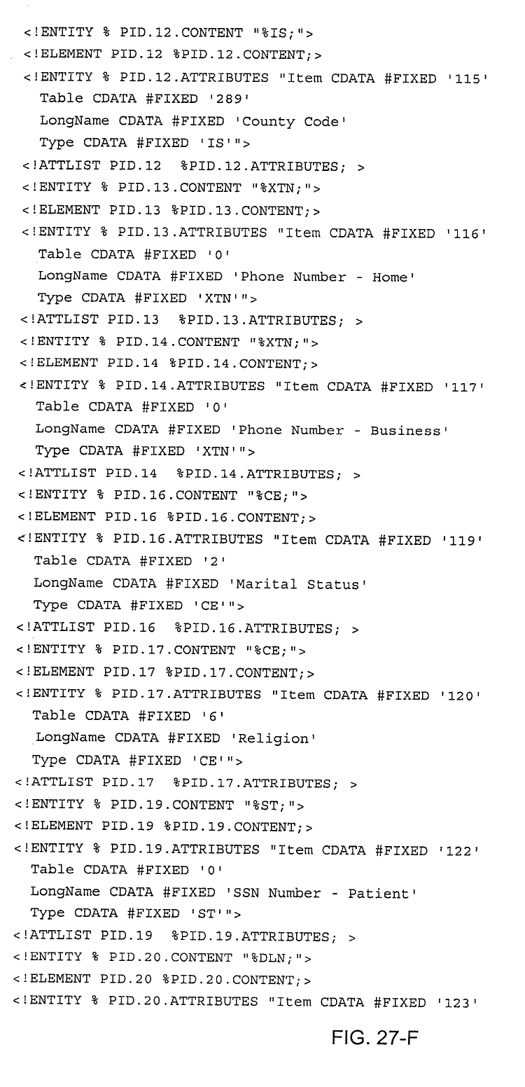

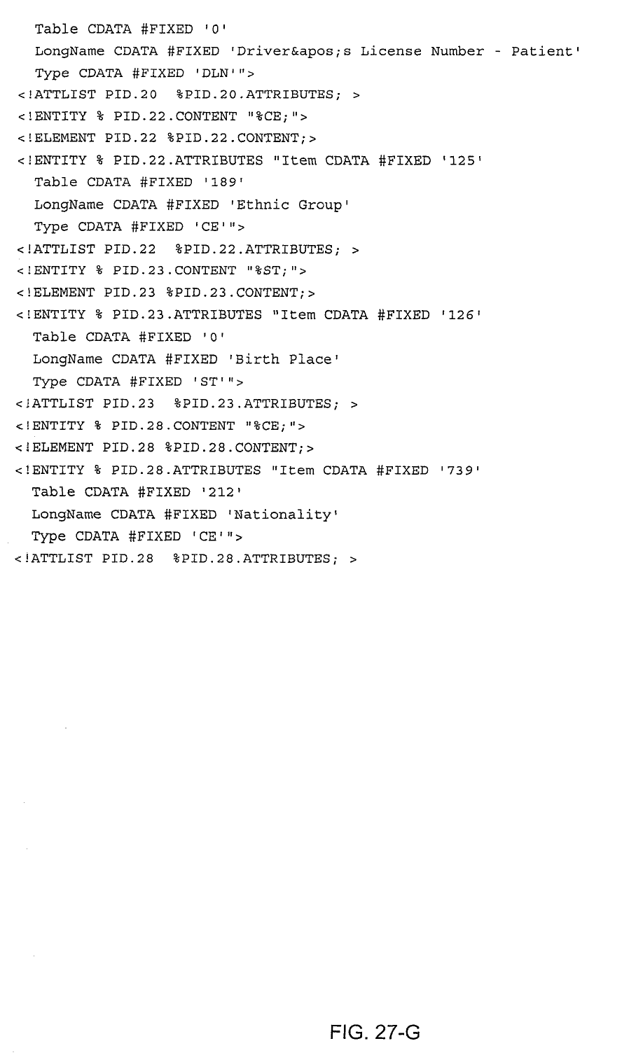

This sequence diagram represents the mechanism that will be used to process demographic data that is received by the exchange. This mechanism is used in many other situations within the exchange to accomplish the loose coupling of applications. The interchange begins when the external system, 1801, posts an HTTP message to the servlet, 1802. The servlet is a standard Java servlet that provides web developers with a simple, consistent mechanism for extending the functionality of a web server and for accessing existing business systems. The serviet first uses the methods of ebXMLParser object 1803 to parse the XML document based on the appropriate HL7 admission, discharge or transfer (ADT) transaction (see FIG. 27 for an example). The ebXMLParser object is created by the constructor method ebXMLParser( ), and is now in memory and receives the method calls parse( ), followed by getebXMLHeader( ) and getxmlpayload( ). These methods parse the incoming XML document into an in memory representation, then strip off necessary information in the header of the document and finally strips off the payload of the document.

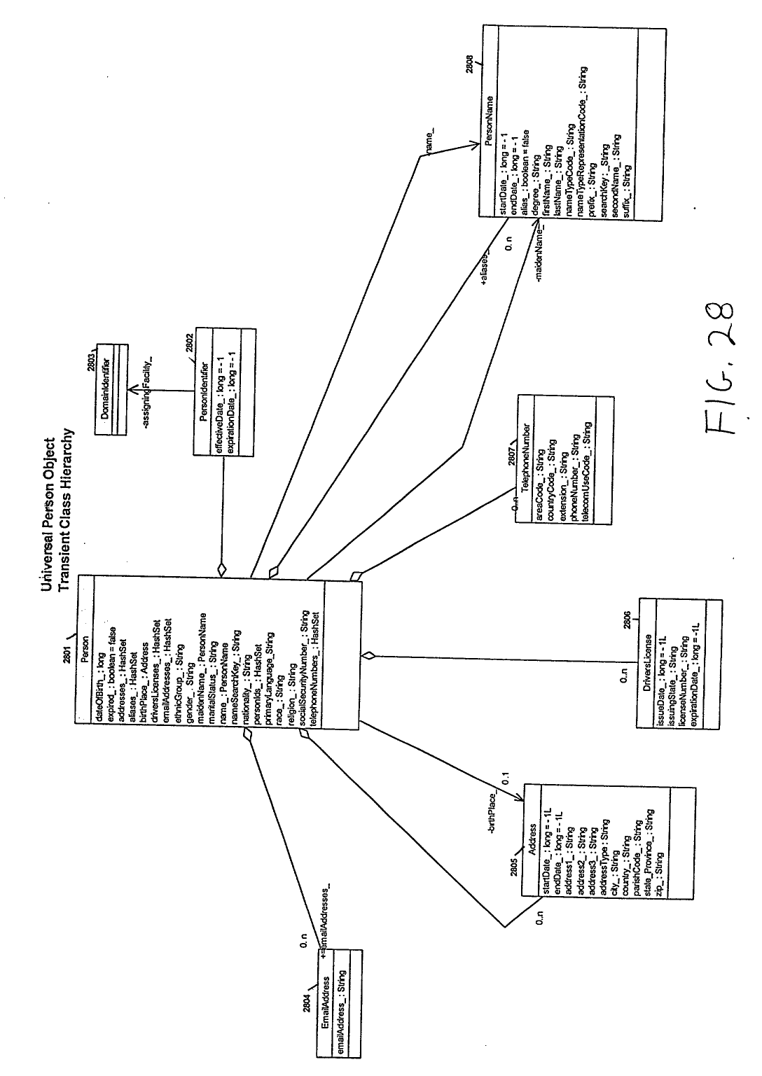

Next the serviet uses baseHandler object 1804 to determine a specific type of handler to use—in this case the Handler object 1805. This object evaluates the contents of the XML payload document and uses the information within it to instantiate a Person object, 1807. This is a transient person object (see FIG. 28 and the accompanying description for more information) that contains the person demographic information in an in-memory programming language object.

Subsequently, the servlet requests the header information from the ebXMLHeaderHandler object, 1806. The servlet now uses the services of the mailDispatcher object, 1809, to return any errors encountered during processing to a specified error handling URL.

The servlet sends the person object to a PersonDataListener object, 1808. This objects function is to forward the data (the Person object) onto queue 1810. The Queue is an instance of a standard message queue, in this case Java message queue, although many similar queue products could easily be substituted. When the person object is put onto the Queue an onMessage event is triggered that causes the PersonIdServiceMonitor 1811 to remove the Person object, forward it to a PersonidServiceDispatcher 1812 that then calls an addPerson routine of the PersonIdServiceImpI object 1813. The argument passed to the PersonIdServiceImpI object is the transient Person object created at the beginning of the sequence from the parsed XML data. The PersonIdServiceImpI object subsequently calls the correlation system, 1814 and the Person object is compared against existing person objects within the system. If the Person object already exists, any new information (e.g. new identifiers) are added to the existing person object creating an effective universal person object. If the correlation system does not find a match, the transient Person object, that has been dealt with thus far, is transitioned into a persistent one and stored in the object database as the universal person object. The parameter passed in to this method is list of attributes that describes that person and these attributes are then used to correlate the person against other known person records.

FIGS. 19-21 relate to how access decisions and policies are managed in one embodiment of the present invention. FIG. 19 shows the sequence of the interaction between a client, 1901, a target object, 1902 (in this case an ADO client), and an access decision block, 1903. Communications between the various objects are handled by the CORBA object request broker, 1904. The target object communicates through interface 1905 and the access decision object communicates through interface 1906.

At step 1, an application client invokes an operation of the interface provided by the target object. The object request broker transfers this request to the target object and causes invocation of the appropriate method in the target object. While processing the request, the target object requests authorization decision(s) from the access decision object at step 2 by invoking an access_allowed( ) method of the ADO (described in further detail with reference to FIG. 20). The access decision object consults other objects that are internal to the RADS to make an access decision. The access decision is returned to the target object (ADO client) as a Boolean decision at step 3. The target object, after receiving an authorization decision, is responsible for enforcing the decision. If the ADO granted access, the target object performs the requested operation and returns the results at step 4. If access to secured resources was denied, the target object may return partial results or raise an exception to the client at step 4. The RADS specification uses HRAC as an acronym for Health Resource Access Control. In the RADS design, authorization logic is encapsulated within an authorization facility that is external to the application (“Scope is HRAC”). In order to perform an application-level access control, an application requests an authorization decision from such a facility and enforces that decision (“Scope is Application”).

FIG. 20 shows how an access decision being requested by a client, 2001 invokes the access_allowed( ) method of the access decision object (ADO), 2002, passing a ResourceName, operation, and SecAttributes. The ADO consults a Dynamic Attribute Service, 2003, to obtain an updated list of SecAttributes that include any dynamic attributes currently applicable for this access decision. The Dynamic Attribute Service may consult externally provided dynamic attribute evaluators as part of its implementation. The AccessDecision object also consults the PolicyEvaluatorLocator, 2004, to obtain object references for the PolicyEvaluator(s), 2005, and the DecisionCombinator, 2006, that are required for an access decision. The access-decision object consults the DecisionCombinator that consults with any PolicyEvaluators responsible for interpreting access policy that controls access to the ResourceName/operation. The DecisionCombinator encapsulates policy combination logic and is responsible for understanding the policy that controls how a series of results from PolicyEvaluators are combined including any precedence rules that may apply. It is the response from the DecisionCombinator that is returned to the client. The ADO client, 2001, is any client application that is seeking a decision regarding access to a data element. In the context of the exchange server this will be the patient identification services and the clinical information locator services.

Policy 2007 and SecuredResource are data stores that capture the known policies on each data element and the resources that are secured by the RAD services. A SecuredResource is a data type that is represented by its ResourceName 2109 and has one or more operations on it they will be secured. Operations include such activities as creating, reading, updating and deleting the secured resource.

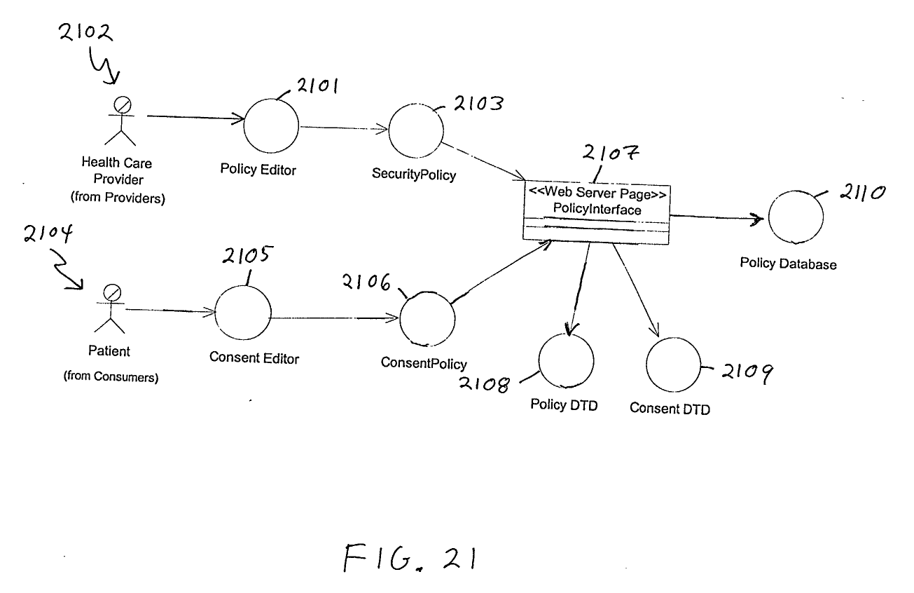

FIG. 21 shows the components needed to capture policy and consent information according to one embodiment of the invention. A policy editor, 2101, is provided to health care providers and administrators, 2102. Health care providers can grant access to peers based on need. Administrators can create security policies 2103 that apply to all of their clinical data. A second interface is provided to patients 2104 in the form of a consent editor, 2105, allowing them to supply consent information concerning their clinical data. This can be at any level of granularity. The consent policy, 2106, as well as the security policy, 2103, is submitted to a web server having policy interface 2107 over HTTPS where they are evaluated for correctness against DTD's 2108 and 2109 and written to a policy database, 2110. This information is now available to RADS to be used to evaluate the policy or policies that apply to any given piece of clinical information.

FIG. 22 depicts the system and method of an embodiment by which patient demographic data is evaluated in a correlation system and a universal person object is generated. Two neural networks, a general match neural network, 2201, and a special match neural network, 2202, form network committee 2203. The general match neural network is primarily responsible for matching common textual, or string based, data that is found in most health information systems. The special match neural network is responsible for matching data of a more complex nature—especially biometric and image data that is captured to identify a person. Biometric data might include fingerprint or retinal scan information. Image data might include a photograph of the person. To start, the two neural networks are given a sample data set, 2204 and 2205 as training data in step 1. This information allows the learning algorithms of the networks to establish appropriate weights for the transition arcs of the network. This operation takes place prior to the actual runtime operation of the network.

At runtime, a request to find a patient is sent to the RMI/IIOP based interface, 2206 of a PID service, 2207. The request is called addpersono. At step 2 the PID server sends a request to the CorrelationSystem interface, 2208 of the correlation system 2209. This interface forwards the request at step 3 to a heuristics based system that is used to evaluate the textual data and normalize it. This heuristics based system handles such problems as normalizing out noise (e.g. street vs. st.), aliases (Steven vs. Steve) and phonetic error (ph vs f). Once the data has been normalized it is passed to an adaptive boost mechanism (AdaBoost), at step 4. In step 5 the adaptive boost mechanism forward the request to the neural networks, 2201 and 2202. Each of these networks executes a weak learning algorithm. Each network evaluates the patient demographic or biometric data against the data found in the database of universal person objects, 2212. As each network completes its evaluation, a hypothesis is formed that describes the match or matches that are found in the network algorithms. These hypotheses are sent to the AdaBoost mechanism that originally started the networks at step 6. The AdaBoost calculates the error probability of the hypotheses and sets a new weight vector. The AdaBoost then outputs a new hypothesis that represents the output of the network committee. The output will determine that a match exists or it does not. If the match exists, any new information will update the existing universal person object in the database 2212 in step 7a. If the universal person object is not correlated against an existing person a new person object will be created at step 7b.

Also shown in the diagram is the query of the database of person objects. A query to find the correlated person is submitted via PIDS findCandidates( ) method at interface 2206. The PID service 2207 performs a search in the database 2212 in step 8. Depending on the type of query performed the PID system may be able to do a fast search using the identifier that is passed to it in the query, or it may be necessary to perform a correlation by following the path described above and passing in the demographic or biometric data as parameters to the query.

FIG. 22 illustrates one example of a correlation system that can be used to implement the invention. It is shown by way of example. Other correlation systems can be used, and there are variations on the correlation system shown in FIG. 22. For example, in addition to the adaptive boost, a secondary boost can be used.At runtime, a request to find a patient is sent simultaneously an the adaptive boost mechanism and the secondary boost mechanism. In this case, the two boost mechanisms forward the request to the neural networks (from the AdaBoost) or to a Bayesian network. Each of these networks executes a weak learning algorithm. Each network evaluates the patient demographic data against the data found in the database. In this case, the hypothesis is compared against a hypothesis generated from the Bayesian network and its weight table. The second boost mechanism calculates the error factor for each hypothesis again, generates a new weight vector and outputs the match.

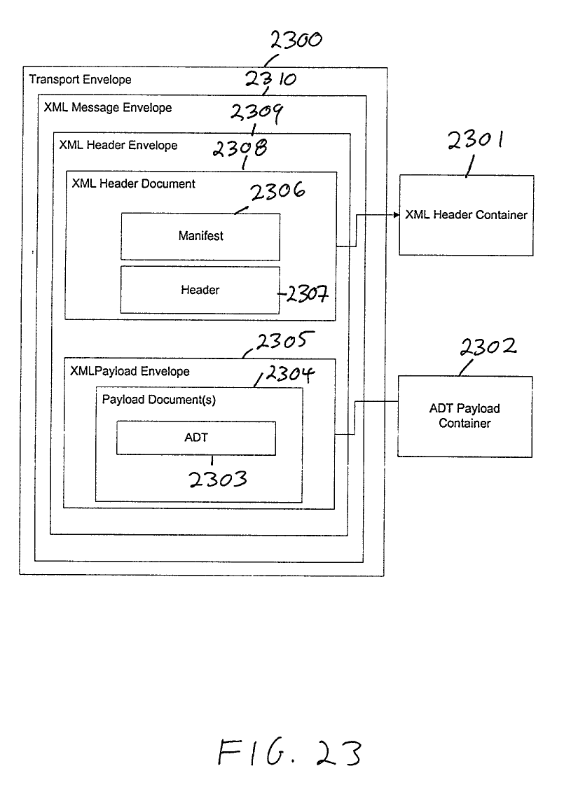

FIG. 23 describes the ebXML-compliant method used to transmit data in a “write metadata” transaction. Separate header and payload containers, 2301 and 2302, respectively, promote system efficiency, as the ebXML messaging service only needs to access the header information to process the message. Patient data is encapsulated in an ADT payload container. Multiple payloads 2304 can exist in a single transport envelope 2305. This provides a flexible mechanism for transparently passing diverse payloads without having to process them within the messaging service framework. It also allows encrypted and/or signed payloads to be exchanged and forwarded with no processing overhead. ebXML is an international initiative established by the United Nations Centre for Trade Facilitation and Electronic Business (UN/CEFACT) and the Organization for the Advancement of Structured Information Standards (OASIS); their goal is to standardize XML business specifications. The current version of the architectural specification is ebXML Technical Architecture Specification 0.9, published Oct. 17, 2000, which is incorporated herein by reference. An ebXML Message consists of an optional transport protocol specific outer communication Protocol Envelope and a protocol independent ebXML Message Envelope. The ebXML Message Envelope is packaged using the MIME multipart/related content type. MIME is used as a packaging solution because of the diverse nature of information exchanged between partners in eBusiness environments. For example, a complex business-to-business transaction between two or more organizations might require a payload that contains an array of documents (XML or other document formats), binary images, or other related business objects.

The ebXML Message Envelope is used to encapsulate the Components of an ebXML compliant message. This structure effectively separates ebXML header information from the payload content of the message. The separation of Header and Payload containers promotes system efficiency, as the ebXML Messaging Service only needs to access Header information to process the message. This provides a flexible mechanism for transparently passing diverse Payloads to appropriate business services without having to process them within the Messaging Service framework. It also allows encrypted and/or signed Payloads to be exchanged and forwarded with no processing overhead.

The ebXML Payload Container is an optional part of an ebXML Message. If a payload is present in and ebXML message, the ebXML Payload Envelope serves as the container for the actual content (payload) of the ebXML message. The ebXML Payload Envelope consists of a MIME header portion and a content portion (the payload itself). The ebXML Messaging Service does not limit in any way the structure or content of payloads.

The required Manifest element identifies the payload document(s) contained in the ebXML Message Container. The purpose of the Manifest is to make it easier to directly extract a particular document associated with the Message. The Manifest contains a list of references to the other parts of the message. This includes references to the documents, which comprise the Payload of the Message. The Header contains the information required by the recipient to process the message. The message originator creates this information to which additional information MAY be added. The Header element is a composite element comprised of the following required subordinate elements:

From

To

TPAInfo

MessageData (ADT messages)

The TPAInfo element is a composite set of information that relates to the Trading Partner Agreement under which the message is governed.

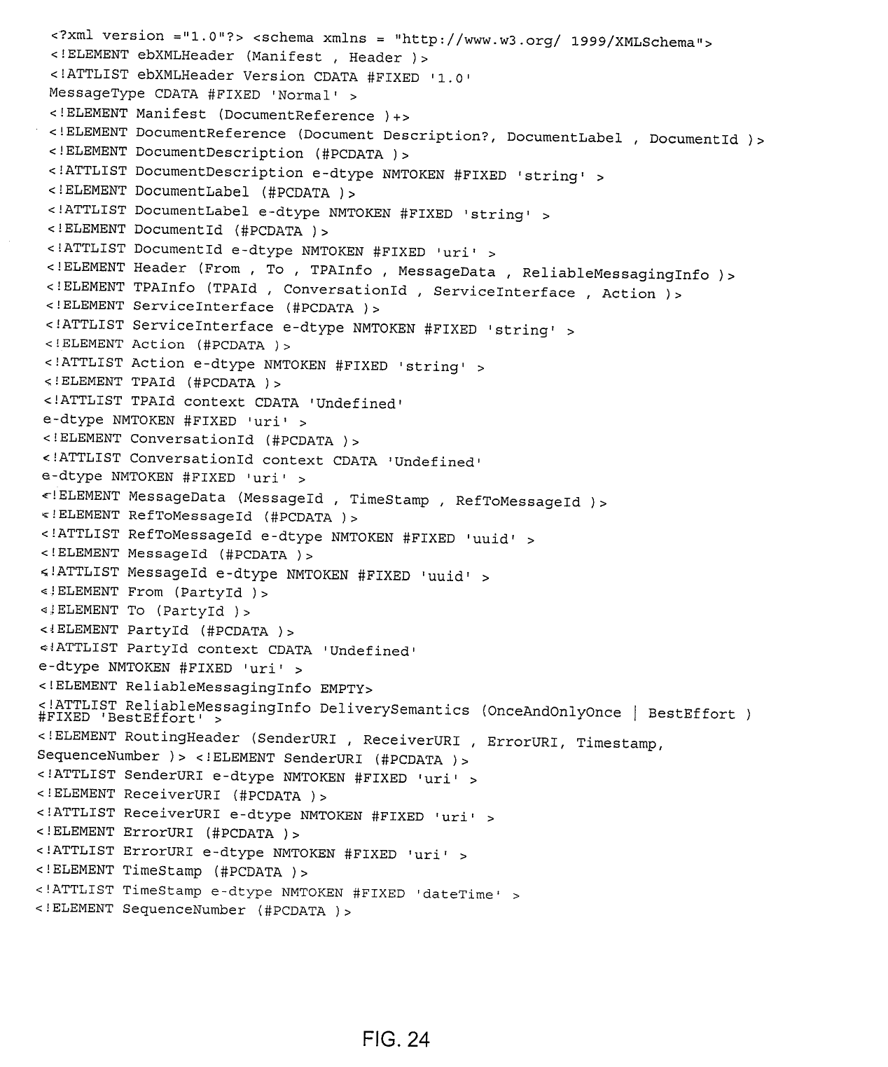

FIG. 24 provides an example XML document type definition (DTD). This DTD is used to describe the message envelope and the payload containers transmitted to the system in a “write metadata” transaction.

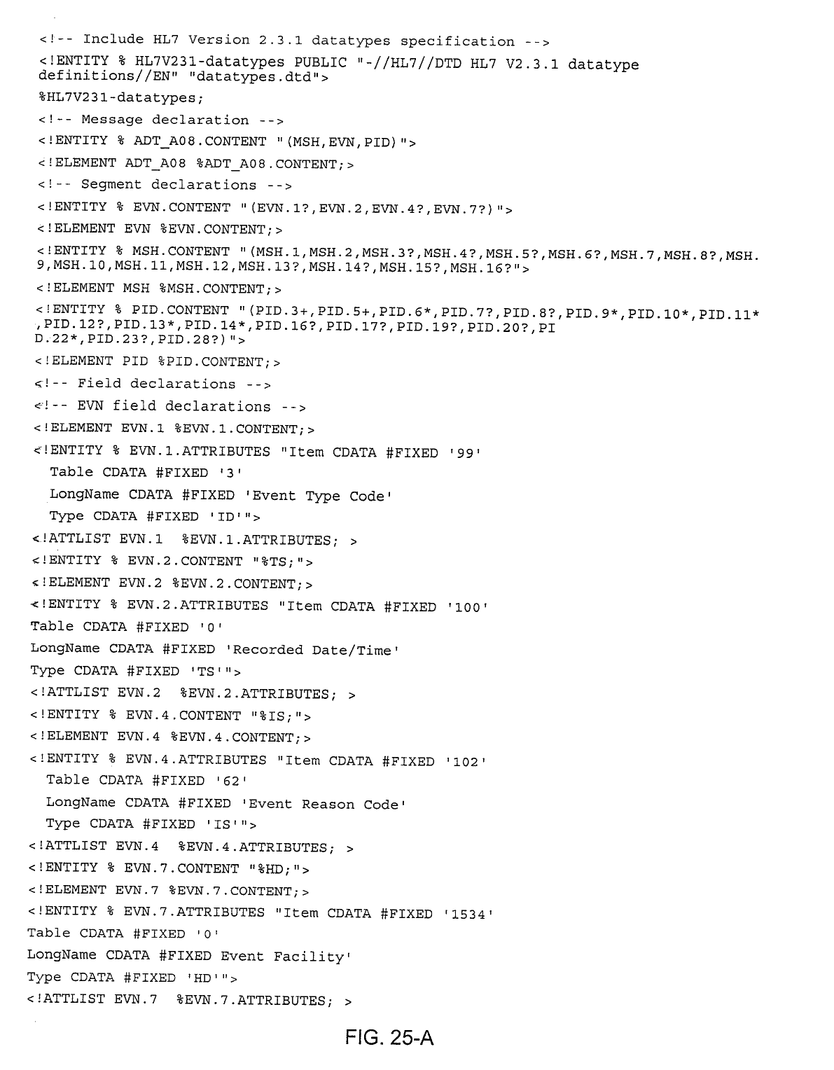

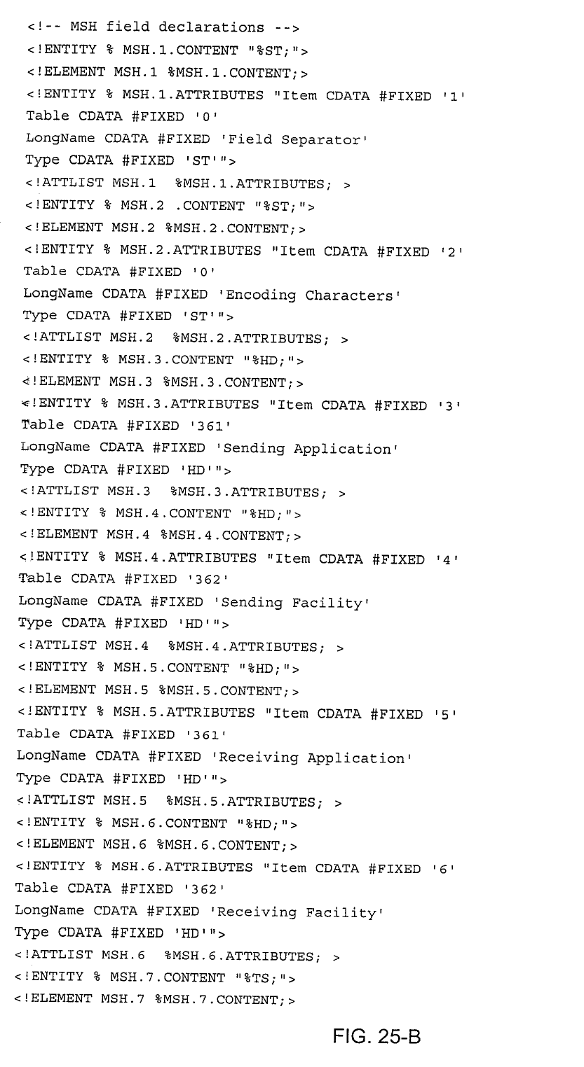

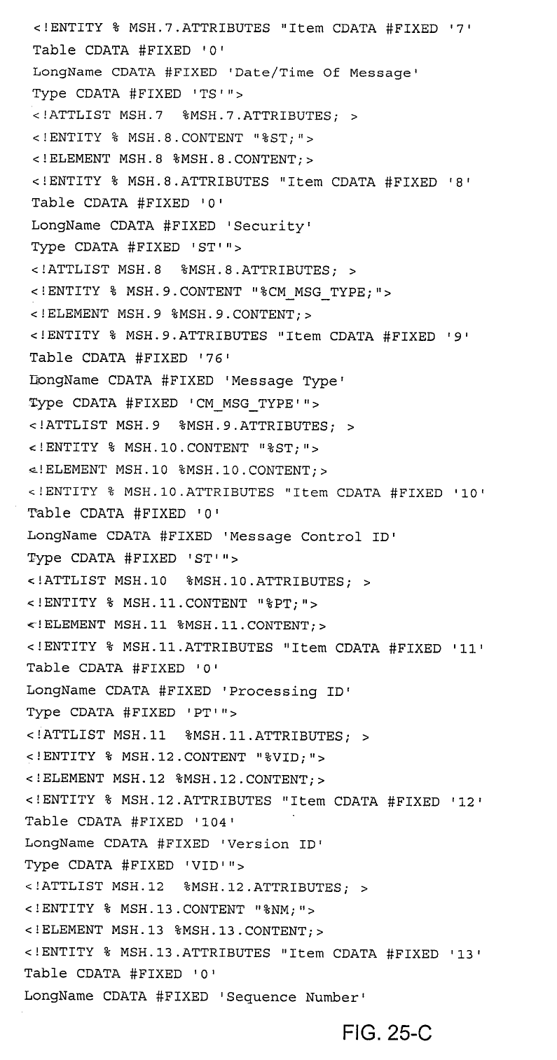

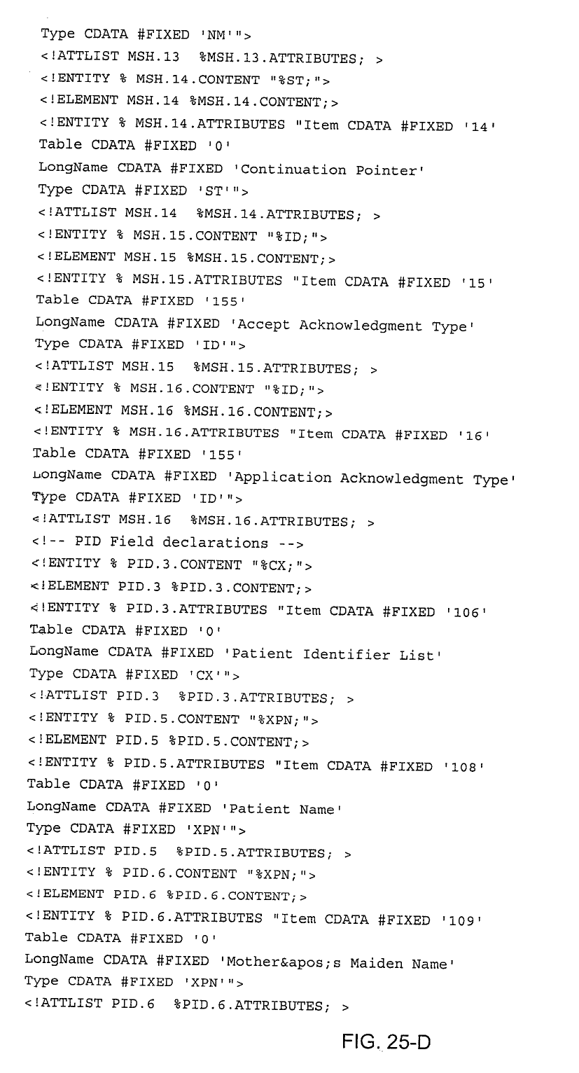

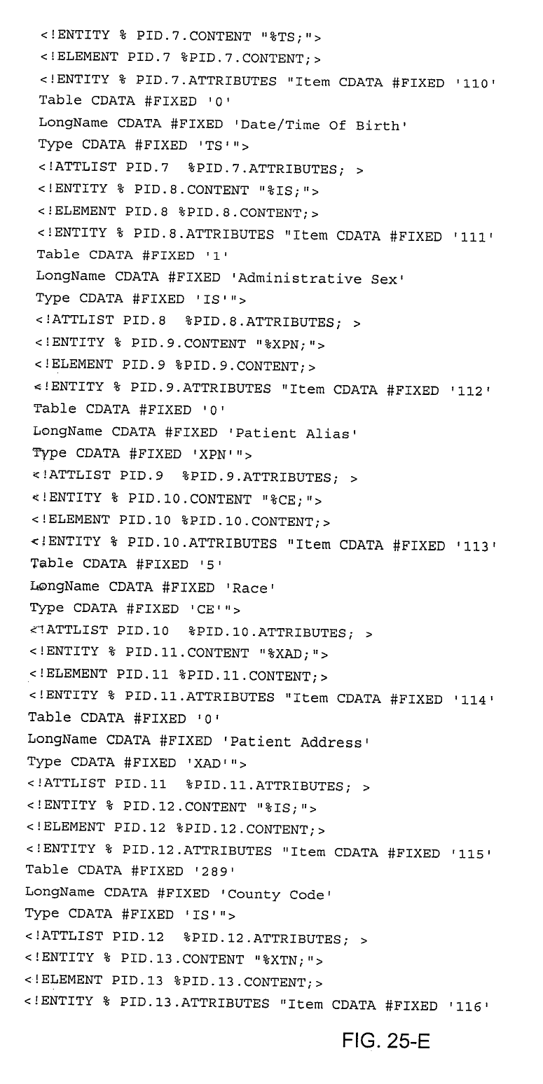

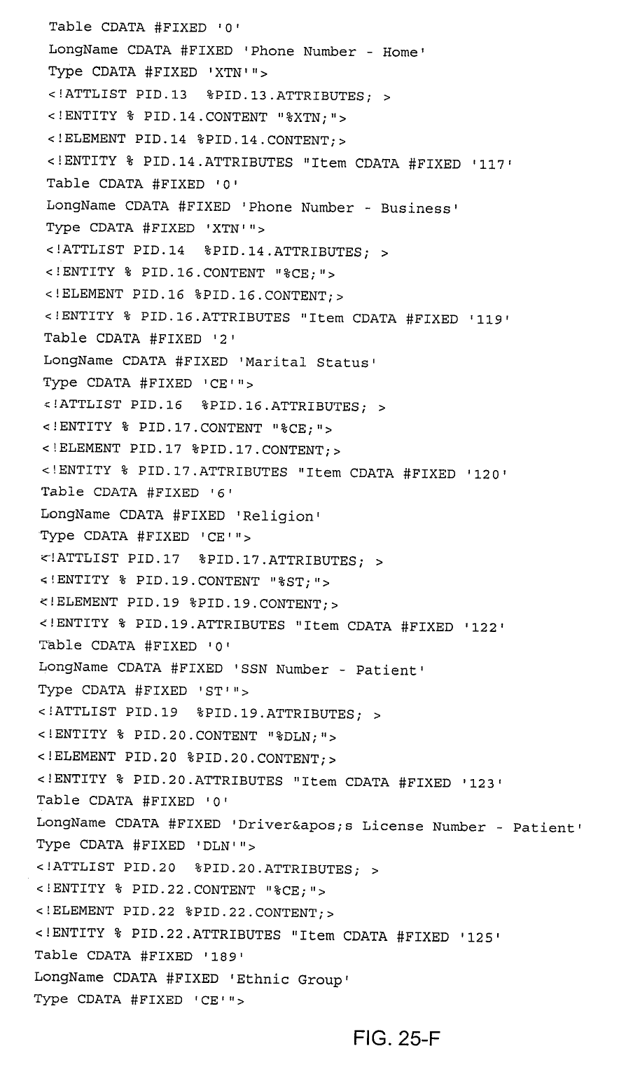

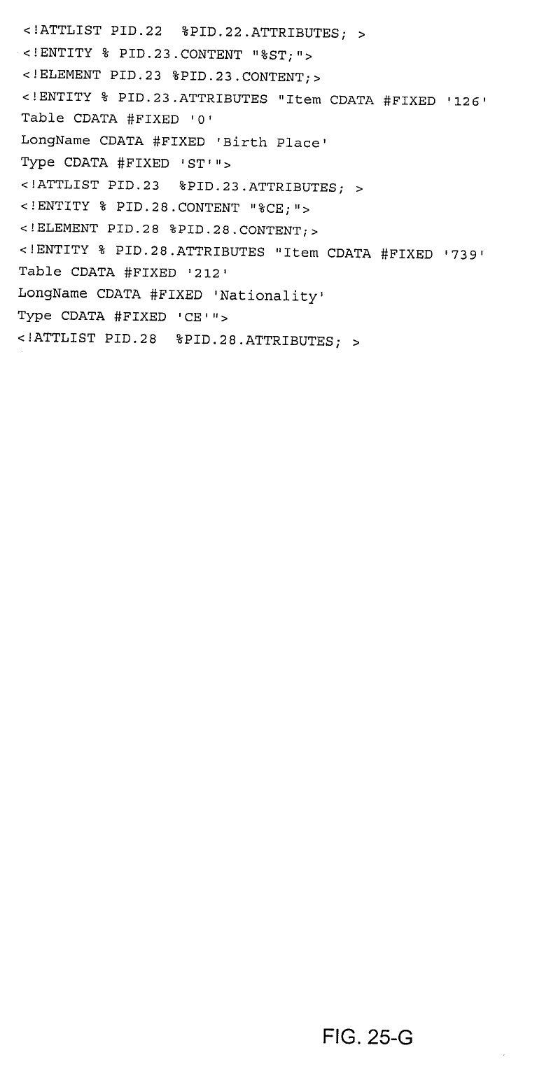

FIG. 25 provides an example XML DTD used to describe the data transmitted in a “write metadata” transaction. FIG. 25 is divided into FIGS. 25-A through 25-G for convenient viewing.

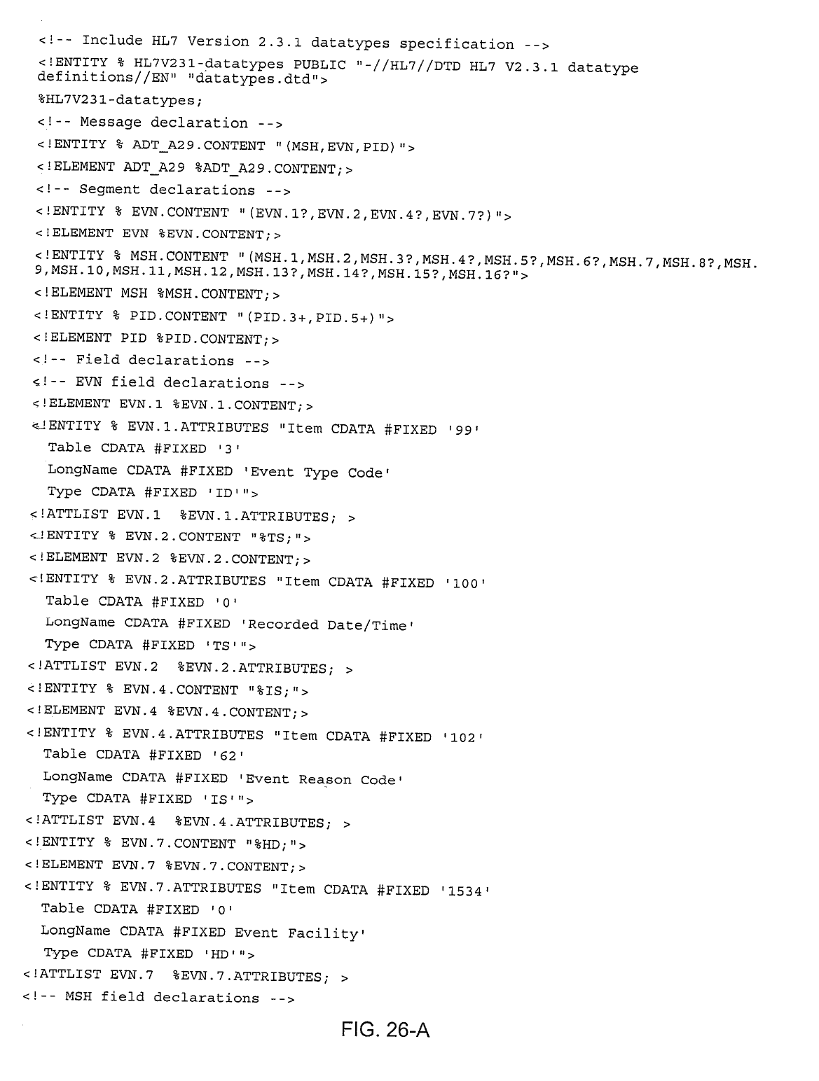

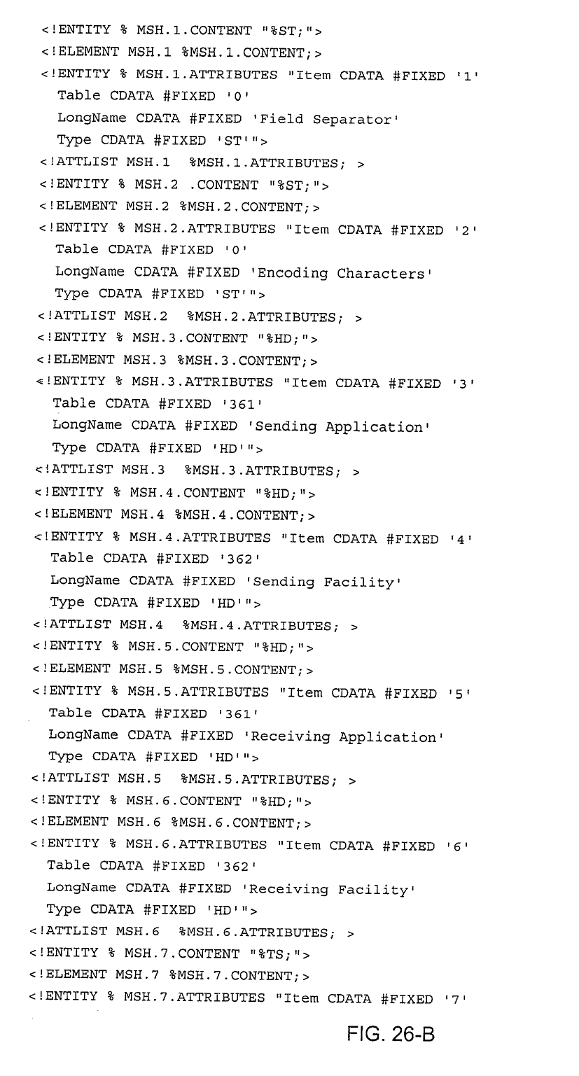

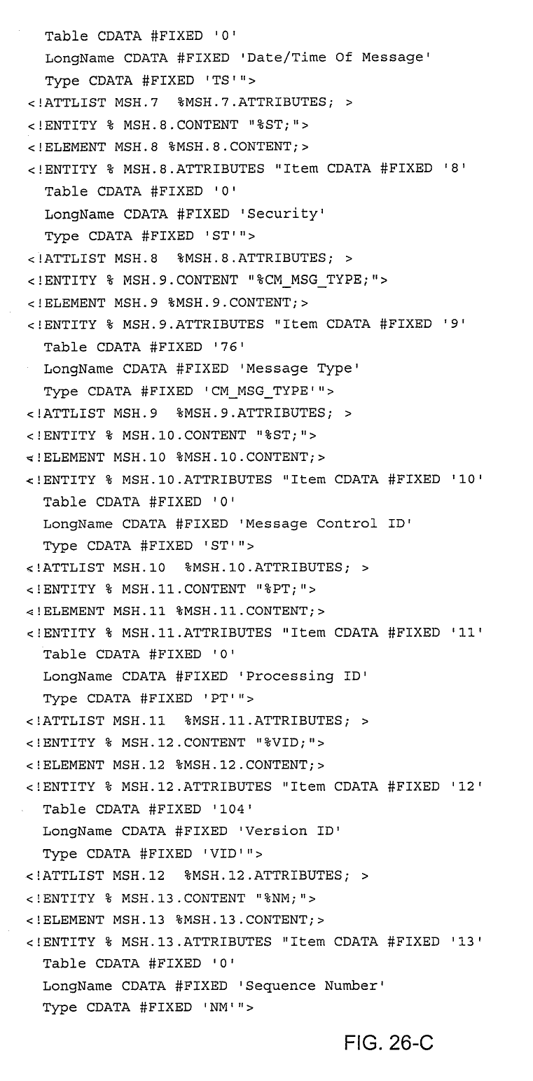

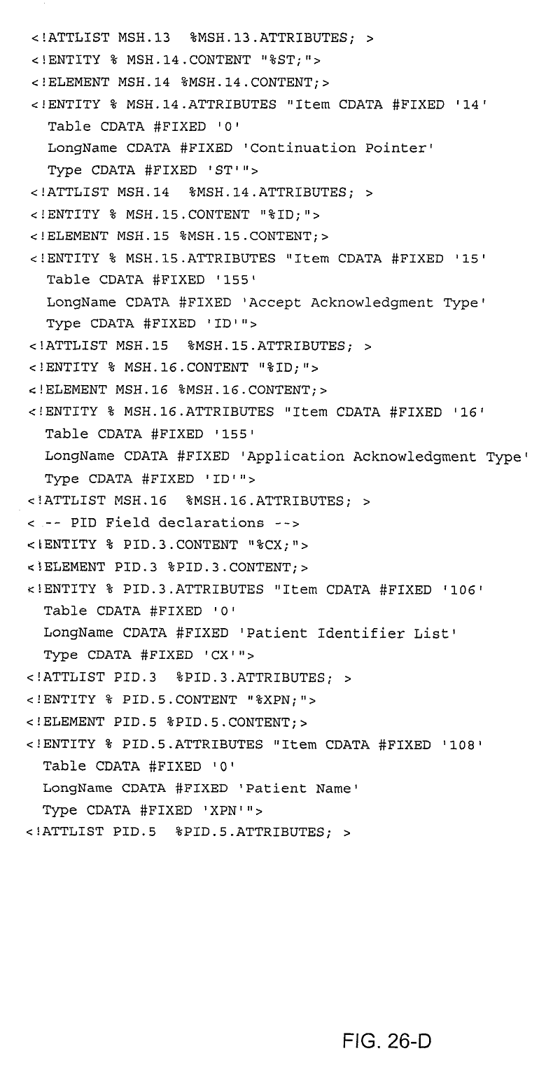

FIG. 26 provides an example XML DTD used to describe the data transmitted in “delete metadata” transaction. FIG. 26 is divided into FIGS. 26-A through 26-D for convenient viewing.

FIG. 27 provides an example XML DTD used to describe the data transmitted in “merge metadata” transaction. FIG. 27 is divided into FIGS. 27-A through 27-G for convenience.

FIG. 28 illustrates the class hierarchies for the entities associated in the exchange server for identifying and finding patients, their providers and the organizations that have provided treatment. This hierarchy defines the universal person object that establishes patient identity in the exchange. Rather than rely on a generated or artificial identifier or key, the exchange relies on the rich set of demographic data and history that becomes a universal person object. This class hierarchy allows the exchange to capture several complex relationships between a person and the many attributes that are a part of the person.

Person class 2801 has a number of attributes such as dateOfBirth, ethnicGroup, gender, nationality, primaryLanguage, race and socialSecurityNumber, all self-explanatory. Additionally, there are some more complex data elements—such as birthPlace, which is an Address type or maidenName which is a PersonName, 2808, type. More distinctively, the person class holds aggregations of the numerous other complex data types such as the emailAddress class, 2804, the Address class, 2805, the driversLicense class, 2806, and telephoneNumber class 2807. The Person class can hold references to many instances of these data elements and can further track their history based on start and end dates. This capability is important in tracking changes in a person's life while still being able to correlate them with their other data elements. FIG. 28 uses standard notations for aggregation (a diamond at the end of a connector), association (an arrow at the end of a connector), and numbers of entries or values captured, (0 . . . n or 0 . . . 1 for example).

The Personidentifier class, 2802, is one of the most critical classes in the hierarchy. This person identifier class is closely associated with the DomainIdentifier class, 2803. The domain identifier tells what organization or system has provided the identifier. This allows the system to track multiple identifiers for a person. Additionally, the system can identify the local identifiers used within any given health care provider organization or even with individual systems within that the provider organization. Moreover, by comparing multiple identifiers that are global to a domain 20 such as a state patient identifier—the task of correlation is made easier and more precise.

Multiple associations are shown between Person class 2801 and the Person-Name class 2808. This diagram illustrates the use of the PersonName class to identify the person's name and optionally a maiden name as attributes within the Person class. Additionally, any number of aliases from 0 to n may be captured as shown by the aggregation relationship.

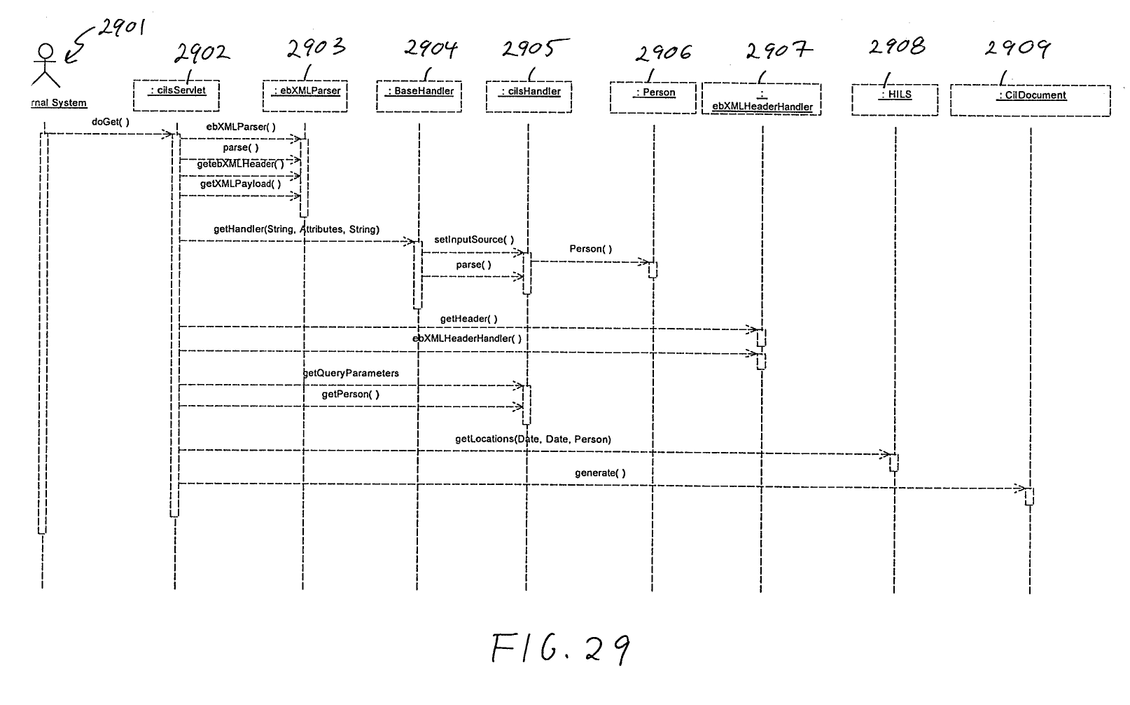

In addition to the capability to receive patient demographic data or locator information, it is necessary to answer queries that will use the correlated and processed data. FIG. 29 describes the mechanism for processing a query to find where a patient has been seen and what records might be available for that patient. FIG. 29 is a sequence diagram describing details of how an external clinical system requests a location from the exchange.

This sequence diagram represents the mechanism that will be used to process queries for locations of clinical information that are received by the exchange. As in previous sequence diagrams, all of the boxes across the top of the diagram represent programming language objects. In this case, the interchange begins when external system 2901 posts an HTTP message to the cilsServlet, 2902. The cilsServlet first uses the methods of ebXMLParser object 2903 to parse the XML document. The ebXMLParser object is created by the constructor method ebXMLParser( ). This is now an in memory object that then receives the method calls parse( ), followed by getebXMLHeader( ) and getXmlPayload( ). These methods parse the incoming XML document into an in memory representation, then strip off necessary information in the header of the document and finally strips off the payload of the document.

Next the cilsServlet accesses a baseHandler object, 2904 that instantiates a specific type of handler to use—in this case, cilsHandler object 3005. This object evaluates the contents of the XML payload document and uses the information within it to instantiate Person object 2906. This is a transient person object (described with reference to FIG. 28) that contains the person demographic information in an in memory programming language object. Among other demographic datum are the local identifier and the assigning authority used by the organization making the request. This information has already been used by the system to make a correlation. It is now a relatively simple matter to use the information in a query to find where else the patient has been seen and what records are available for the patient. Subsequently, the cilsServlet requests the header information from the ebXMLHeaderHandler object, 2907.

The cilsServlet includes the Person as a parameter in a request to the health information locator service (HILS), 2908. This service performs the queries necessary and accesses the database to find the required information. Additionally, the HILS may invoke the query at other locations via a trader function and compile a list of locators across a distributed network of information trading partners. The HILS also uses the RADS to filter the information based on the consent and policy parameters that apply to the data. The HILS instantiates CilDocument 2909. This XML document is returned to the requesting external system.

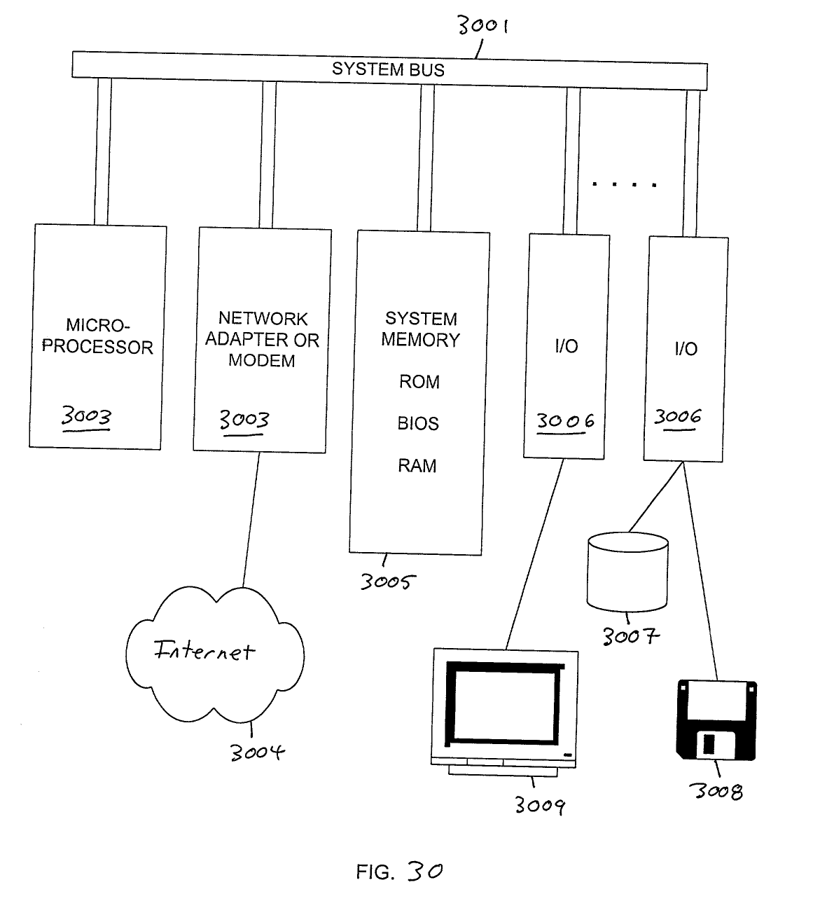

Although the distributed nature of the invention cannot be overemphasized, much of the software that is used to implement the invention resides on and runs on one or more computer systems, which in one embodiment, are personal computers, workstations, or servers. One node of a network in which the invention is being implemented can be formed by one such computer system, running appropriate software. FIG. 30 illustrates further detail of a computer system that is implementing part of the invention in this way. System bus 3001 interconnects the major components. The system is controlled by microprocessor 3002, which serves as the central processing unit (CPU) for the system. System memory 3005 is typically divided into multiple types of memory or memory areas, such as read-only memory (ROM), randomaccess memory (RAM) and others. If the computer system is an IBM compatible personal computer, the system memory also contains a basic input/output system (BIOS). A plurality of general input/output (I/O) adapters or devices, 3006, are present. Only two are shown for simplicity. These connect to various devices including a fixed disk, 3007, a diskette drive, 3008, and a display, 3009. The computer program instructions for implementing the functions of the invention performed at a particular node are stored on the fixed disk, 3007, and are partially loaded into memory 3005 and executed by microprocessor 3002. The system also includes another I/O device, a network adapter or modem, shown at 3003, for connection to the Internet, 3004, or to other types of networks which allow this node to communicate with other nodes. It should be noted that the system as shown in FIG. 30 is meant as an illustrative example only. Numerous types of general-purpose computer systems are available and can be used. Available systems include those that run operating systems such as Windows™ by Microsoft and various versions of UNIX.

As previously mentioned, appropriate computer program code in combination with the appropriate hardware and networks implements the invention. This computer program code is often stored on storage media. This media can be a diskette, hard disk, CD-ROM, DVD-ROM, or tape. The media can also be a memory storage device or collection of memory storage devices such a read-only memory (ROM) or random access memory (RAM). Additionally, the computer program code can be transferred over the Internet or some other type of network. The diskette drive of FIG. 30 is indicated by a drawing of one type of media, a diskette, which can be used to initially transfer some of the computer program code of the invention to the computer system of FIG. 30. A diskette typically includes magnetic media enclosed in a protective jacket. Magnetic field changes over the surface of the magnetic media are used to encode the computer program code. Data structures used in implementing the invention, such as the universal person object and the correlation system, can be encoded in one or more media or memory systems at a single node or distributed across the network.

We have described specific embodiments of an invention, which provides a method and system for the exchange of information in a secure manner. One of ordinary skill in the networking, computing, and records management arts will quickly recognize that the invention has other applications in other environments. In fact, many embodiments and implementations are possible. The following claims are in no way intended to limit the scope of the invention to the specific embodiments described.

We claim:

1. A method of building a database in an exchange system to enable the location of distributed health care information, the method comprising the steps of:
receiving metadata including organization information, patient demographic data, and information locator data;
determining a universal person object corresponding to the demographic data;
updating the universal person object in accordance with the metadata; and
storing the information locator data so that the information locator data is associated with the universal person object.

2. The method of claim 1 wherein the determining step further comprises the steps of:
searching the database for an existing universal person object corresponding to the patient demographic data and determining that there is no existing universal person object corresponding to the patient demographic data; and
creating the universal person object corresponding to the patient demographic data.

3. The method of claim 1 wherein the determining step further comprises the step of searching the database and locating the universal person object corresponding to the patient demographic data.

4. The method of claim 1 further comprising the step of, after the updating step, forwarding the universal person object to a parent server.

5. The method of claim 2 further comprising the step of, after the updating step, forwarding the universal person object to a parent server.

6. The method of claim 3 further comprising the step of, after the updating step, forwarding the universal person object to a parent server.

7. A method of locating particular information pertaining to a person wherein the particular information is stored among distributed information, the method comprising the steps of:
receiving a query from a provider;
correlating the query against at least a primary database in at least a primary domain to locate a universal person object corresponding to the person;
retrieving locator data associated with the universal person object;
filtering the locator data according to one or more policies; and
presenting the locator data to the provider.

8. The method of claim 7 further comprising the steps of:
determining if a pointer exists in the primary database, the pointer indicating a remote database in a remote domain; and
if the pointer exists, correlating the query against the remote database in the remote domain.

9. The method of claim 7 further comprising the steps of:
presenting correlation results to the provider; and
receiving constraints and parameters from the provider, the constraints and parameters for directing the retrieving of the locator data.

10. The method of claim 8 further comprising the steps of:
presenting correlation results to the provider; and
receiving constraints and parameters from the provider, the constraints and parameters for directing the retrieving of the locator data.

11. In a network including distributed information, a method of viewing a record for a particular person from within the information, the method comprising the steps of:
sending a query from a provider application to a primary domain server;
correlating the query by accessing at least a primary database in at least a primary domain to locate a universal person object corresponding to the particular person;
retrieving locator data associated with the universal person object;
filtering the locator data according to one or more policies;
presenting the locator data to the provider application;
selecting, at the provider application, one or more records from a remote data system; and
accessing the one or more records from the remote data system by the provider application.

12. The method of claim 11 further comprising the steps of:
determining if a pointer exists in the primary database, the pointer indicating a remote database in a remote domain; and
if the pointer exists, correlating the query by accessing the remote database in the remote domain.

13. The method of claim 11 further comprising the steps of:
presenting correlation results to the provider application; and
setting constraints and parameters at the provider application, the constraints and parameters for directing the retrieving of the locator data.

14. The method of claim 12 further comprising the steps of:
presenting correlation results to the provider application; and
setting constraints and parameters at the provider application, the constraints and parameters for directing the retrieving of the locator data.

15. A computer program product for enabling a server to build a database in an exchange system to enable the location of distributed information, the computer program product including a computer program comprising:
instructions for creating universal person objects;
instructions for receiving metadata including organization information, demographic data, and information locator data;
instructions for searching the database for universal person objects;
instructions for updating a universal person object corresponding to the demographic data in accordance with the metadata; and
instructions for storing the information locator data so that the information locator data is associated with the universal person object corresponding to the demographic data.

16. The computer program product of claim 15 wherein the computer program further comprises instructions for forwarding the universal person objects to a parent server.

17. A computer program product for enabling the locating particular information pertaining to a person wherein the particular information is stored among distributed information, the computer program product including a computer program comprising:
instructions for receiving a query from a provider;
instructions for correlating the query against at least a primary database at least a primary domain to locate a universal person object corresponding to the person;
instructions for retrieving locator data associated with the universal person object;
instructions for filtering the locator data according to one or more policies; and
instructions for presenting the locator data to the provider.

18. The computer program product of claim 17 wherein the computer program further comprises:
instructions for determining if a pointer exists in the primary database, the pointer indicating a remote database in a remote domain; and
instructions for correlating the query against the remote database in the remote domain.

19. The computer program product of claim 17 wherein the computer program further comprises:
instructions for presenting correlation results to the provider; and
instructions for receiving constraints and parameters from the provider, the constraints and parameters for directing the retrieving of the locator data.

20. The computer program product of claim 18 wherein the computer program further comprises:
instructions for presenting correlation results to the provider; and
instructions for receiving constraints and parameters from the provider, the constraints and parameters for directing the retrieving of the locator data.

21. Apparatus for building a database to enable the location of distributed information, the apparatus comprising:
means for creating universal person objects;
means for receiving metadata including organization information, demographic data, and information locator data;
means for searching the database for universal person objects;
means for updating a universal person object corresponding to the demographic data in accordance with the metadata; and
means for storing the information locator data so that the information locator data is associated with the universal person object corresponding to the demographic data.

22. Apparatus for locating particular information pertaining to a person wherein the particular information is stored among distributed information, the apparatus comprising:
means for receiving a query from a provider;
means for correlating the query against at least a primary database at least a primary domain to locate a universal person object corresponding to the person;
means for retrieving locator data associated with the universal person object;
means for filtering the locator data according to one or more policies; and
means for presenting the locator data to the provider.

23. A network including distributed health care information comprising:
a provider application operable to issue queries; and
at least a first server connected to the provider application, and containing a primary correlation system connected to a primary database of universal person objects, the server operable to receive the queries, correlate the queries against the database, and retrieve locator data, the locator data indicating the location of one or more specific records from within the distributed provider information.

24. The network of claim 23 further comprising a second server connected to the first server, and including a remote correlation system connected to a remote database of universal person objects.

25. The network of claim 23 further comprising a remote data system containing at least a portion of the distributed health care information, the remote data system operable to connect to the provider application, format, and supply one or more of the specific records over the network.

26. The network of claim 24 further comprising a remote data system containing at least a portion of the distributed health care information, the remote data system operable to connect to the provider application, format, and supply one or more of the specific records over the network.

27. A programmed computer system operable to build a database in an exchange system to enable the location of distributed health care information by performing the steps of:
receiving metadata including organization information, demographic data, and information locator data;
determining a universal person object corresponding to the demographic data;
updating the universal person object in accordance with the metadata; and
storing the information locator data so that the information locator data is associated with the universal person object.

28. The system of claim 27 wherein the determining step further comprises the steps of:
searching the database for an existing universal person object corresponding to the demographic data and determining that there is no existing universal person object corresponding to the demographic data; and
creating the universal person object corresponding to the demographic data.

29. The system of claim 27 wherein the determining step further comprises the step of searching the database and locating the universal person object corresponding to the demographic data.

30. The system of claim 27 further enabled to perform the step of forwarding the universal person object to a parent server.

31. The system of claim 28 further enabled to perform the step of forwarding the universal person object to a parent server.

32. The system of claim 29 further enabled to perform the step of forwarding the universal person object to a parent server.

33. A programmed computer system which is operable to locate particular health care information pertaining to a person wherein the particular health care information is stored among distributed provider's by performing the steps of:
receiving a query from a provider;
correlating the query against at least a primary database at least a primary domain to locate a universal person object corresponding to the person;
retrieving locator data associated with the universal person object;
filtering the locator data according to one or more policies; and
presenting the locator data to the provider.

34. The system of claim 33 further enabled to perform the steps of:
determining if a pointer exists in the primary database, the pointer indicating a remote database in a remote domain; and
if the pointer exists, correlating the query against the remote database in the remote domain.

35. The system of claim 33 further enabled to perform the steps of:
presenting correlation results to the provider; and
receiving constraints and parameters from the provider, the constraints and parameters for directing the retrieving of the locator data.

36. The system of claim 34 further enabled to perform the steps of:
presenting correlation results to the provider; and
receiving constraints and parameters from the provider, the constraints and parameters for directing the retrieving of the locator data.

37. Apparatus for enabling the location of records from among distributed information, the apparatus comprising:
an information locator service for storing and accessing information locator data;
a database of universal person objects, each universal person object corresponding to a person and associated with information locator data in the information locator service; and
a correlation system connected to the database for correlating demographic information against the database to locate a particular universal person object.

38. The apparatus of claim 37 further comprising a person identification service connected to the correlation system for providing a standard interface for receiving the demographic information.

39. The apparatus of claim 37 further comprising a resource access description service for maintaining and applying policy information to information locator data.

40. The apparatus of claim 38 further comprising a resource access description service for maintaining and applying policy information to information locator data.

41. A memory system encoded with a data structure for defining a universal person object for use in correlating queries for records, the data structure comprising:
a person class including references to person specific data, the person class further being operable to track historical instances of the person specific data;
a person identifier class associated the person class, the person identifier class including references to one or more person identifiers; and
a domain identifier class associated with the person class for identifying one or more systems from which the one or more person identifiers have been received.
